(19) United States
(12) Patent Application Publication
(10) Pub. No.: US 2025/0167589 A1
(43) Pub. Date: May 22, 2025

(54) SERVERS, SYSTEMS, AND METHODS FOR AUTOMATING, INVESTIGATING AND RESOLVING HARMONICS IN AN ELECTRICAL POWER GRID

(71) Applicant: PACIFIC GAS AND ELECTRIC COMPANY, Oakland, CA (US)

(72) Inventors: Charlie Zha, Palo Alto, CA (US); Glenn Aiemjoy, Fair Oaks, CA (US); Sandeep Kataria, Fremont, CA (US)

(21) Appl. No.: 18/950,906

(22) Filed: Nov. 18, 2024

Related U.S. Application Data
(60) Provisional application No. 63/600,227, filed on Nov. 17, 2023.

(51) Int. Cl. H02J 13/00

(52) U.S. Cl. CPC H02J 13/00002

(57) ABSTRACT

In some embodiments, the system includes one or more smart meters specially configured to collect, store, and transmit harmonics data. In some embodiments, the system enables the monitoring and detection of harmonics in utility distribution networks and display potential harmonic issues that can be addressed proactively before impacting utility and customer equipment. In some embodiments, the system contributes to overall lower costs of collecting harmonics data through the specially configured smart meters which reduce labor costs by eliminating truck rolls that would otherwise be dispatched to install portable power quality monitors at random for harmonics investigations. In some embodiments, the automation of harmonics data collection and/or reporting using specially programmed smart meters reduces the exposure of field personnel to high voltage that may be present when installing a power quality monitor on service equipment.

### CROSS-REFERENCE TO RELATED APPLICATION

This application claims the benefit of and priority to U.S. Provisional Application No. 63/600,227, filed Nov. 17, 2023, which is hereby incorporated herein by reference in its entirety for all purposes.

### BACKGROUND

Utility providers are experiencing an increase in harmonic distortion in their Transmission and Distribution (T&D) systems due to the proliferation of distributed energy resources (DERs) such as solar photovoltaic (PV) and power electronics loads such as variable speed drives (VFDs), switched-mode power supplies, and electric vehicle (EV) battery chargers. This modern electrical equipment draws non-linear loads which produce harmonic current that flows back into the power systems.

Non-linear loads, which include loads with current characteristics that do not follow the applied voltage waveform cause harmonic voltage distortion which deteriorates power quality. Power quality is important to both utilities and end users because any deviation from the expected levels of power quality may cause utility equipment damage or malfunctions such as overloading, shortening the equipment's life and reducing efficiency. Poor power quality can also deteriorate the quality of the power deliveries to customers, adversely affecting customer equipment performance or even causing safety issues, system shutdowns, and data loss.

Utilities have seen harmonics impact on both customer and utility equipment in the recent years. Customers have reported that solar PV inverters and EV battery chargers are not operating properly in high-voltage harmonics environments. Utilities also have seen more issues with distribution capacitor banks that have abnormally high amperage readings and, in some cases, prematurely fail.

The harmonic issues are expected to worsen in the future as the proliferation of harmonics sources such as VFDs, DERs, and EV battery chargers in the electric distribution system continue. Furthermore, modern customer equipment is increasingly becoming more sensitive to harmonics due to the use of power electronics. This further highlights the need for continuous or high frequency periodic monitoring of the harmonics levels in distribution systems according to some embodiments, so that a utility can proactively address the harmonic issues before they impact utility and customers' equipment.

Most power systems in North America are designed to operate around 60 Hertz. The addition of other harmonic current frequencies into the system causes harmonic voltage distortion which deteriorates the power quality (PQ) of the electrical power that a utility delivers to customers. Harmonic current also causes adverse effects on utility and customer equipment, such as overloading and heating, shortening equipment's life and reducing efficiency. Harmonic voltage may cause malfunctions of utility and customer equipment. While utilities are responsible for limiting harmonic voltage in the supply voltage, customers are responsible for limiting their harmonic current emissions. However, many customers are not aware they are producing harmonic distortions, and currently there is no way for a utility to identify harmonics at the meter level and/or within a customer's electrical circuit.

Therefore, there is a need in the art for a system configured to analyze and/or identify the sources of harmonic voltage in electrical distribution systems.

### SUMMARY

Typical electrical meters, like standard smart meters, have limited sampling rates designed primarily for measuring basic power consumption and low-frequency parameters. These meters sample at rates between 1 and 10 samples per second, which is sufficient to capture the fundamental power frequency (50 or 60 Hz) and calculate average usage but lacks the granularity to resolve higher-order harmonics. This low sampling rate restricts the meter's ability to measure harmonic distortion accurately, as higher-frequency signals blend into the background due to under sampling. Without adequate sampling resolution, the meter cannot differentiate the finer details of waveforms distorted by harmonics, which are critical for precise power quality analysis.

In some embodiments, the system described herein includes an electrical smart meter configured for harmonic analysis at much higher rates, which can include the kilohertz range. For instance, in some embodiments, the system includes a smart meter configured to sample at a rate of 2 to 5 kHz (2,000 to 5,000 samples per second) enables the detection of harmonic components up to the 50th harmonic in a 50 Hz system (around 2,500 Hz) or the 42nd harmonic in a 60 Hz system (around 2,520 Hz). This higher sampling rate allows the meter to accurately capture the waveform's higher-frequency components, enabling detailed analysis of Total Harmonic Distortion (THD) and individual harmonics across a wide range. In some embodiments, using a specially configured smart meter, the system can measure power quality at a plurality of locations simultaneously, detecting subtle distortions from one or more sources that could affect sensitive equipment or indicate inefficiencies in the distribution network.

An electric utility normally engages in electricity generation and distribution of electricity to end users, such as Commercial and Industrial (C&I) and residential customers. In some embodiments, to accurately detect and locate the harmonics sources, the system is configured to collect harmonic data and demand data from sensors (e.g., customer electrical utility meters), clean and normalize the data, and/or identify the correlation between harmonics and demand data. In some embodiments, to properly calculate the data series correlation, data sources that have the same interval are used. In some embodiments, the metering data is cleaned with synchronized timestamps. In some embodiments, any missing data is interpolated and normalized before the correlation is calculated. A large utility often has over one hundred thousand three-phase commercial and industrial customers and thousands of feeders. Large data volume and increased complexity of new systems make controlling harmonics even more difficult to address.

In some embodiments, the system is configured to clean and prepare the data. In some embodiments, when meter data comes in it can have data missing, which will complicate the calculations. In some embodiments, the system is configured to use linear interpolation to insert any missing meter interval data for both the harmonic meter and regular customer meters. In some embodiments, other interpolation algorithms such as cubic spline, last sampled value, or a constant value approach can be used.

In some embodiments, the system is configured to calculate the harmonic distortion from the aggregated data, and/or display the results upon a user query. In some embodiments, for each customer's meter read, the system is configured to display a correlation between a meter read and Phase A, B or C voltage total harmonic distortion. In some embodiments, the system calculates a correlation coefficient, which quantifies the strength of the relationship between the meter readings and the VTHD. A higher correlation coefficient indicates a stronger relationship, suggesting that changes in the meter readings are closely associated with changes in the VTHD.

In some embodiments, the system is configured to use these correlation results to identify potential sources of power quality issues. As a non-limiting example, if a customer's meter readings show a high correlation with increased VTHD, the system is configured to indicate (e.g., on a display) that the customer's equipment is contributing to harmonic distortion in the power grid. This information can help engineers target specific sources of harmonics and address power quality problems more effectively.

In some embodiments, the system includes two or more smart meters each configured to monitor a respective electrical load. In some embodiments, the system includes one or more computers comprising one or more processors and one or more non-transitory computer readable media, the one or more non-transitory computer readable media including program instructions stored thereon that when executed cause the one or more computers to execute one or more algorithm steps. Some embodiments include a step to receive, by the one or more processors, electrical load data from the two or more smart meters. Some embodiments include a step to receive, by the one or more processors, harmonic distortion data from one or more electrical distribution devices. Some embodiments include a step to execute, by the one or more processors, a correlation analysis that includes the electrical load data from each of the two or more smart meters and the harmonic distortion data. Some embodiments include a step to identify, by the one or more processors, a harmonic distortion source based on the correlation analysis. Some embodiments include a step to output, by the one or more processors, a report identifying the harmonic distortion source.

In some embodiments, the one or more electrical distribution devices include at least one of the two or more smart meters. In some embodiments, the harmonic distortion data is recorded by at least one of the two or more smart meters. In some embodiments, at least one of the two or more smart meters is configured to sample electrical waveforms at a frequency greater than 60 Hz. In some embodiments, at least one of the two or more smart meters is configured to sample electrical waveforms at a frequency greater than 300 Hz. In some embodiments, at least one of the two or more smart meters is configured to sample electrical waveforms at a frequency between 1000 Hz and 6000 Hz.

In some embodiments, at least one of the two or more smart meters is configured to detect harmonics greater than or equal to a 7th harmonic. In some embodiments, at least one of the two or more smart meters is configured to detect harmonics occurring in a feeder. In some embodiments, the feeder is configured to supply electricity to the two or more smart meters.

In some embodiments, identifying the harmonic distortion source includes displaying an area on a map a location where the harmonic distortion source has been identified. In some embodiments, identifying the harmonic distortion source includes identifying which of the two or more smart meters are coupled to the electrical load causing harmonic distortion. In some embodiments, the one or more electrical distribution devices include a power quality monitor. In some embodiments, the one or more electrical distribution devices include a phasor measurement unit installed on a distribution line. In some embodiments, the one or more electrical distribution devices include a line sensor installed on a distribution line.

In some embodiments, outputting the report includes displaying the harmonic distortion source on a graphical user interface. In some embodiments, outputting the report includes displaying harmonics data for at least one of the two or more smart meters. In some embodiments, outputting the report includes displaying harmonics data at a feeder level. In some embodiments, at least one of the two or more smart meters is configured to collect total voltage harmonic distortion data and/or total current harmonic distortion data. In some embodiments, at least one of the two or more smart meters is configured to send the total voltage harmonic distortion data and/or the total current harmonic distortion data to a utility server at predetermined intervals.

### DRAWING DESCRIPTION

FIG. 1 shows the network infrastructure for a harmonics data collection system according to some embodiments.

FIG. 2 shows an application interface diagram according to some embodiments.

FIG. 3 shows a meter data flow diagram according to some embodiments.

FIG. 4 illustrates a non-limiting harmonics dashboard according to some embodiments.

FIG. 5 shows a list of all AMPQs according to some embodiments.

FIG. 6 shows meter level details according to some embodiments.

FIG. 7 shows a VTHD time series chart according to some embodiments.

FIG. 8 shows an ITHD/TDD time series chart according to some embodiments.

FIG. 9 shows feeder circuit breaker amps and VAR reactive power according to some embodiments.

FIG. 10 depicts Feeder line recloser amps and VAR reactive power according to some embodiments.

FIG. 11 shows a harmonics correlation as Feeder VTHD and customer demand time series according to some embodiments.

FIG. 12 shows a list of customers on the feeder and their corresponding harmonics correlation score according to some embodiments.

FIG. 13 shows a comparison between the voltage total harmonic distortion (VTHD) data from the AMPQ and from a traditional PQM that was installed at the same location according to some embodiments.

FIG. 14 shows a comparison of ITHD data from AMPQ and PQM according to some embodiments.

FIG. 15 shows VTHD time series charts from 180 AMPQ locations according to some embodiments.

FIG. 16 depicts the number of AMPQs with VTHD readings exceeding IEEE 519 limit on a weekly basis according to some embodiments.

FIG. 17 illustrates the number of feeders that have AMPQs reporting VTHD higher than IEEE 519 limit according to some embodiments.

FIG. 18 shows Average VTHD readings of all 180 AMPQs according to some embodiments.

FIG. 19 depicts average VTHD readings by division generated by the system according to some embodiments.

FIG. 20 shows VTHD readings by divisions generated by the system according to some embodiments.

FIG. 21 depicts the health of the systems from harmonics perspective which is about 85% at the lowest point in the summer and about 98-99% in the winter and spring according to some embodiments.

FIG. 22 shows an example of comparing feeder VTHD variation with the feeder loads from CB and LR according to some embodiments.

FIG. 23 shows an example of feeder harmonics and different value of customer demand correlation score according to some embodiments.

FIG. 24 shows a non-limiting system architecture according to some embodiments.

FIG. 25 shows an acronym list for one or more terms used herein according to some embodiments.

FIG. 26 illustrates a computer system 110 enabling or comprising the systems and methods according to some embodiments.

FIG. 27 shows a channel configuration for an AMPQ in accordance with some embodiments.

FIG. 28 illustrates IEEE limits according to some embodiments.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se.). The following detailed description is, therefore not intended to be taken in a limiting sense.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently and/or simultaneously, or the blocks can sometimes be executed in the reverse order, depending upon the functionality/acts involved. In some embodiments, the terms “harmonic distortion,” “harmonic issues” and “harmonics” are used interchangeably throughout this disclosure when discussed in relation to voltage quality in power systems.

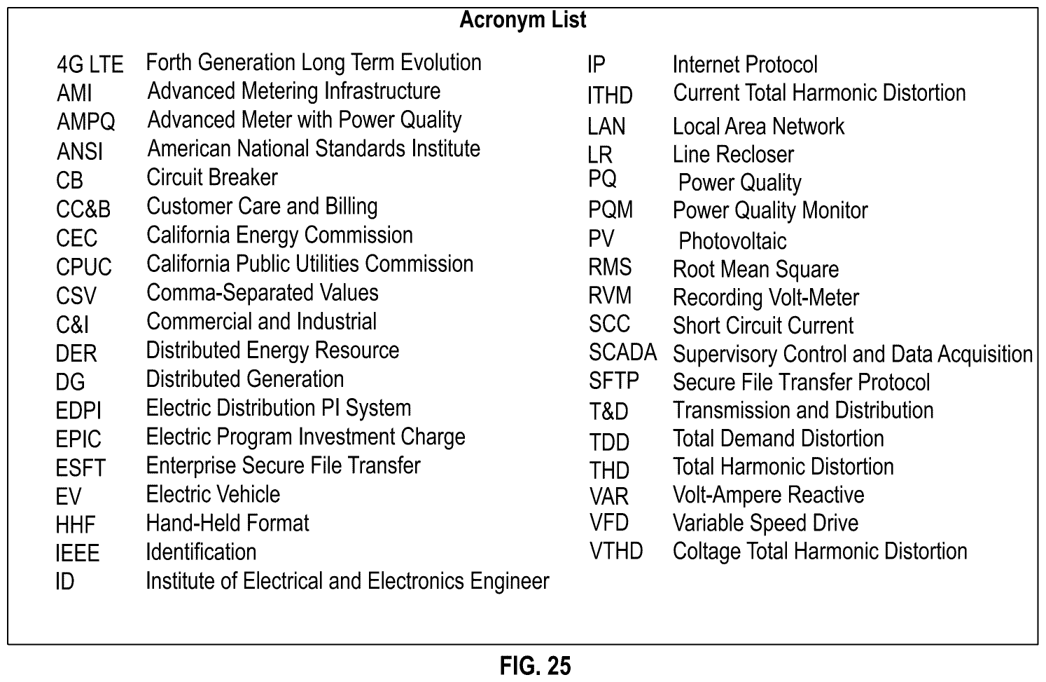

There are many acronyms used to describe various portions of the system; therefore, an acronym list is proved in FIG. 25 for quick reference.

In some embodiments, the system uses analytical methods performed on data obtained from a smart meter configured to identify and/or store that harmonic data. In some embodiments, this data is used by the system to detect, analyze and/or mitigate harmonic(s) issues. In some embodiments, the system includes one or more sensors and/or a specially configured computer integrated into a smart meter, which is referred to herein as an Advanced Meter with Power Quality (AMPQ). In some embodiments, the AMPQ is configured to identity and store high-resolution power quality data, which includes harmonics, to support grid operations and/or troubleshooting power quality issues. By collecting harmonics data on a large scale, the system is configured to identify where there are harmonic issues in a distributed electrical network, and/or provide one or more root causes for the harmonic issues. By using an AMPQ to collect harmonics data, according to some embodiments, the system reduces costs, improves safety, and improves customer satisfaction by allowing utilities to continuously monitor, detect, and proactively address harmonic issues.

In some embodiments, the system is configured to collect harmonics data using a harmonics data collection device (e.g., a portable power quality monitor (PQM)) installed in same circuit as that being metered. In some embodiments, the circuit may include a number of individual electrical transmission lines that supply electricity to one or more loads (e.g., lights, appliances, equipment, batteries. In some embodiments, the electrical circuit may include alternative power sources, such as batteries, wind turbines, and/or solar panels, which supply the one or more loads as an alternative and/or in addition to the utility. In some embodiments, the electrical circuit is also configured to supply electricity through the meter, which may include the AMPQ.

While effective, the process of dispatching a truck roll to collect harmonics data using a PQM takes up significant time, as field personnel must install, download, and remove PQMs. In some embodiments, the harmonics data is collected reactively as a response to customer complaints using the PQM. However, in some embodiments, the system is configured to continuously monitor harmonics in an electrical distribution network (i.e., utility network) by using one or more smart meters connected to the network, wherein the network includes a plurality of electrical meters monitoring electrical circuits such as those found in homes, industrial settings, and/or alternative power sources.

In some embodiments, the AMPQ is configured to continuously collect harmonic data and transmit the harmonic data, and/or results of harmonic data analytics, on demand, periodically, and/or continuously, allowing the system to monitor network harmonics regularly, as well as enabling the system to take actions to mitigate harmonic issues before the issues impact utility and customer equipment. By using the AMPQ in conjunction with the system functionality described herein, a utility can free up significant resources and increase operational efficiency by eliminating the need for a reactive response.

The harmonic issues in a utility's distribution network are seasonal issues because the sources of harmonics are predominantly customers' loads which vary seasonally. Therefore, in some embodiments, the system is configured such that harmonic data is collected over weeks and months from many locations to execute a harmonic analysis. Customers typically report harmonic issues impacting their equipment during the summer months when the harmonics level in the distribution systems is the worst. This also coincides with the season when the distribution systems loads are highest, and field resources are prioritized for circuit switching, maintenance, and emergency response.

Field personnel must access live electrical panels and transformer enclosures to install PQM which exposes field personnel to electrically energized parts and creates a safety risk of electrical shock and arc flash. In some embodiments, working with AMPQ is much simpler and safer because it is installed in a meter socket, accessible from the front of the meter panel where there are no exposed energized parts, thus reducing safety risk when field personnel perform the work. In some embodiments, the AMPQ is configured to transmit the data to a remote location and/or computer, eliminating the need for field personnel to re-access the panel to manually download data from the PQM, further reducing the exposure to electrical hazards. In some embodiments, a method of using the system includes replacing an existing meter to an AMPQ to collect billing data and/or harmonics data maximizing the use of a single electric meter socket, which reduces costs since the cost of a AMPQ is only a fraction of the cost of a PQM. In some embodiments, the system is configured to collect sufficient harmonic data for power quality engineers to investigate customer harmonics complaints. In some embodiments, harmonic data often includes periods of time where no harmonics data is available. Without historical harmonics data readily available when customers report harmonic issues, it is challenging to address and resolve customers complaints in a timely manner because after PQMs are installed, days and sometimes weeks or months must pass to collect enough harmonics data for analysis. PQM resources are also limited, so it is not feasible to use PQMs to collect harmonics data on an electrical distribution network to understand how widespread harmonic issues are and where they come from without using the system and methods described herein.

To help address these issues, in some embodiments, the system is configured to collect harmonics data and/or generate a harmonics dashboard and/or analysis tools that power quality engineers can utilize to investigate harmonic issues. In some embodiments, the system is configured to collect harmonics data for a power quality investigation. In some embodiments, the system automates the collection and processing of harmonics data from the AMPQs. In some embodiments, the system is configured to create a Harmonics Dashboard that facilitates monitoring and analysis of harmonics in utility distribution systems. In some embodiments, the system is configured to analyze the harmonics data to assess harmonics in the supply voltage that a utility provides to customers and determine how widespread and severe the harmonic issues are in the systems.

In some embodiments, the system includes analysis tools that power quality engineers can use to investigate and resolve harmonic issues. For example, in some embodiments, the system is configured to use signal attenuation models to identify an area where harmonics are being produced. Physical lines have inherent resistance and inductance, which cause the harmonic signal's amplitude to diminish over distance. Higher frequencies (like those in higher-order harmonics) typically experience greater attenuation, so meters farther from the source measure lower levels of harmonic distortion, especially in higher frequencies.

In some embodiments, the system is configured to use resonance and/or line impedance models to identify an area where harmonics are being produced. Utility lines and transformers have impedance characteristics that can amplify or attenuate certain harmonics based on the distance and configuration of the network. Resonance at specific harmonic frequencies can cause amplification at certain points, causing one meter to read higher distortion levels than others, depending on its location relative to the source and line impedance.

In some embodiments, the system is configured to use line losses and/or dispersion models to identify an area where harmonics are being produced. In physical transmission lines, especially those used in utility networks, higher-frequency harmonic components experience more losses due to conductor skin effect and dielectric losses. This effect is more pronounced in longer distances, leading to lower harmonic readings at meters farther away from the source, particularly for higher-frequency harmonics.

In some embodiments, the system is configured to executed models that take into account interference and/or reflection at line junctions in the analysis to identify an area where harmonics are being produced. Reflections can occur at points where there are changes in line impedance, such as at transformers or junctions. This may cause constructive or destructive interference, altering harmonic levels at various points in the network, which meters at different distances read differently.

By using one or more models in the analysis the system is configured to display, by the one or more processors, areas producing higher harmonics than areas producing lower and/or no harmonics. The area may be a geographical area, such as a parameter on a map, or, in some embodiments, the area includes high-capacity lines (feeders) that span long distances to deliver power from substations to the service areas, or an area may include a combination of both, where the dashboard is configured to display either or both. As the source of the harmonics may not be an electrical circuit monitored by an AMPQ, this analysis improves the harmonic source identification process by allowing utility providers to focus resources, such as PQM distribution and/or AMPQ distribution, in a defined area to locate the actual source.

Some embodiments include a step of deploying AMPQs in locations across the service territory covering electric distribution feeders. In some embodiments, the AMPQs include one or more non-transitory computer readable media comprising program instructions stored that cause one or more computers to collect and transmit harmonics data remotely. In some embodiments, the system includes a cloud-based IT network system that automates the collection and processing of harmonics data from the AMPQs. In some embodiments, the system pulls loads data from distribution equipment such as feeder circuit breakers (CBs), line reclosers (LRs), and demand data from smart meters for harmonics correlation analysis.

In some embodiments, the system is configured to generate a distribution system harmonics analytics dashboard, which includes a data visualization and analysis tools to monitor and investigate harmonics in the feeders where AMPQs and/or PQMs are installed. As a result of the system and methods described herein, the harmonics data collected by the system has been able to identify that feeders and/or areas that have high harmonics include a lot of agricultural VFD pumps.

In some embodiments, AMPQ can reliably collect harmonics data including total voltage harmonic distortion (VTHD) and/or total current harmonic distortion (ITHD). In some embodiments, the harmonics data from AMPQs are comparable to that from PQM and therefore either can be used to detect harmonic issues in the distribution systems.

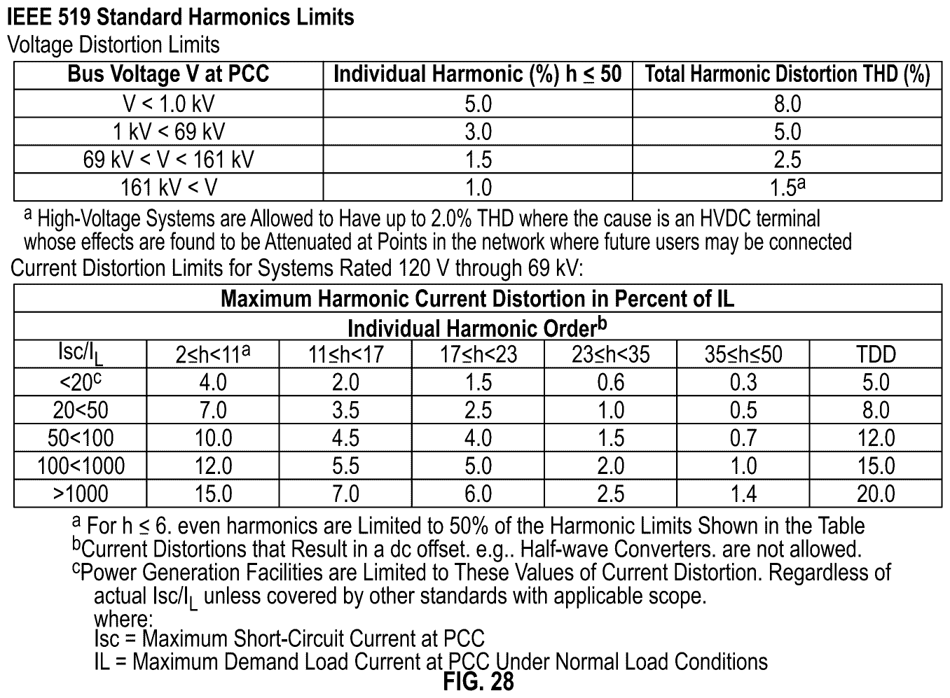

In a non-limiting analysis performed by the system, in the summer months, up to 33 of 125 distribution feeders monitored had voltage harmonics level exceeds the recommended limits per IEEE 519 standard. FIG. 28 illustrates IEEE limits according to some embodiments. In the winter months, the number of feeders having high voltage harmonics was down to 4-5 feeders. In some embodiments, the results generated by the system confirm that the harmonic issues in utility distribution systems are currently seasonal.

The voltage harmonics levels in most of the distribution feeders in the were within IEEE 519 limit. However, for the feeders that had high voltage harmonics, some of them far exceed the recommended limit by as much as twice. The system was able to identify feeders that had voltage harmonic distortion up to 15-20%, which would likely cause issues for customer sensitive equipment.

In some embodiments, the system revealed many distribution feeders having high level of voltage harmonics previously unknown to utilities, mainly in agricultural distribution feeders. Additional field investigation confirmed the major source of harmonics in utility distribution system are variable speed drive pumps.

In some embodiments, the system is configured to analyze harmonics data from the AMPQs in conjunction with other data from electric distribution devices and smart meters to determine the source of harmonics. In some embodiments, the harmonics data is configured to identify issues on the utility side, such as capacitor bank resonance, that may worsen harmonics.

In some embodiments, the AMPQs are installed separately alongside the existing revenue meters already installed at customer meter panels. In some embodiments, this approach requires that a spare meter socket is available at customer meter panels. In some embodiments, the system includes a dual-socket meter adapter for converting a single meter socket, coupled to an electrical circuit, into a dual-socket arrangement. In some embodiments, the one or more computers are stored in a single socket adaptor which is placed between the smart meter and the meter socket. In some embodiments, the single socket adapter is configured to interface with the smart meter's computer and/or network to deliver harmonics data. In some embodiments, the single socket adaptor includes one or more computers and one or more communication networks configured to operate independently of the smart meter. In some embodiments, the combination of a dual-socket adaptor, single socket adapter, and/or a smart meter forms an AMPQ.

In some embodiments, the system includes integration and maintenance of data pipelines from multiple sources to the harmonics dashboard. In some embodiments, data pipelines include one or more AMPQs, PQMs, electric distribution network devices, and/or one or more non-AMPQ smart meters. In some embodiments, the one or more smart meters are AMPQs. In some embodiments, these different datasets are processed and synchronized to provide data visualization and run calculations for the harmonics dashboard. In some embodiments, a daily report for data download and process is generated by the system to provide alerts when there are issues with the data pipelines, so that the problems can be detected and fixed as quickly as possible.

In some embodiments, some non-limiting electrical distribution devices that form at least part of the system and/or are used in at least part of the system analysis include one or more of voltage monitors, current sensors, fault indicators, line temperature sensors, phase measurement units (PMUs), transformer monitors, load tap changer (LTC) monitors, capacitor bank controllers and monitors, pole-mounted sensors (for remote monitoring), remote terminal units (RTUs), and battery monitoring systems (BMS).

In some embodiments, the system is configured to use voltage monitors to detect deviations in voltage waveforms from an ideal and/or historical data, which are used in the analysis to detect harmonic distortion patterns. These variations in voltage allow the system to identify areas of the network with high harmonic presence in accordance with some embodiments. In some embodiments, current sensor measured fluctuations in current are used by the system to identify harmonic loads, identifying areas where non-linear loads-such as electronic devices or variable-speed drives—are creating harmonics that stress the network.

In some embodiments, fault indicators are used in the analysis to reveal areas where harmonics have led to increased fault occurrences, such as short circuits, due to the additional stress harmonics place on electrical components. By identifying fault-prone locations, the system can isolate areas where harmonic distortion is likely a contributing factor, and/or exclude areas from consideration. Line temperature sensors identify hotspots on conductors, where the system is configured to correlate to excess reactive power associated with harmonics. Higher-than-expected temperatures at specific points are used by the system to identify harmonic-induced heating in accordance with some embodiments.

In some embodiments, phase measurement units (PMUs) are configured to obtain precise, synchronized data on phase angles across voltage and current waveforms, which the system uses for tracing harmonic-related phase distortions network-wide. By comparing phase angle deviations, PMUs allow the system to accurately determine the area of the source of the harmonics. In some embodiments, transformer monitors track parameters such as temperature, load, and voltage in real time, flagging overheating caused by harmonic distortion.

In some embodiments, a load tap changer (LTC) monitors measure adjustments in voltage levels managed by transformers. In some embodiments, abnormal tap-changing activity is used to determine harmonic presence, as the harmonic distortion can force LTCs to make excessive adjustments, adding wear. In some embodiments, capacitor bank controllers and monitors track harmonic levels directly by recording how frequently the capacitor banks are switched in response to harmonics. High levels of harmonic current cause abnormal cycling, which is used by the system to identify points on the network where harmonic levels are significant enough to damage capacitor banks if left unchecked, ultimately saving maintenance cost.

In some embodiments, pole-mounted sensors provide distributed voltage and/or current data at strategic locations throughout the network. In some embodiments, this spatial data enables harmonics mapping across multiple areas in the dashboard, allowing utilities to isolate harmonic sources and evaluate the spread of harmonic levels within the distribution system. In some embodiments, remote terminal units (RTUs) consolidate data from various monitors before sending the data back to a central control center, where the harmonics are analyzed by a larger computer framework (e.g., cloud network) for harmonic trends.

In some embodiments, the system includes battery monitoring devices configured to monitor harmonic effects on batteries. Harmonics impact charging and discharging rates, which can reduce battery efficiency and lifespan. Data from the battery monitoring devices are used by the system to determine how harmonics are influencing battery cycles. In some embodiments, the system is configured to display identified patterns of one or more electrical distribution devices and/or area concentrations of harmonic distortion on the dashboard. In some embodiments, the system is configured to send an alert and/or notification of identified harmonics to one or more remote devices.

In some embodiments, the system is configured to collect harmonics data from AMPQs and/or distributed network devices over a cellular network (e.g., 4G LTE). In some embodiments, the time taken to read and process harmonics data from one AMPQ over a cellular network ranges between 5-10 minutes, and some AMPQs take significantly longer if there is poor cellular coverage at the installation sites. In some embodiments, to overcome this challenge, the system includes one or more servers configured to collect and process the data from the AMPQs. In some embodiments, as the number of AMPQs increases, the data bandwidth and storage may be an issue and parallel processing is executed by the system. In some embodiments, harmonics data collection using AMPQ is transmitted to a central server and/or supervisory control and data acquisition (SCADA) platforms for analysis and/or display using the existing AMI network rather than and/or in conjunction with a cellular network.

In some embodiments, harmonics and other power quality data collection are operationalized and integrated into a utility metering infrastructure in production environment. In some embodiments, a method includes distributing AMPQ in the geographical service areas identified as having high harmonics levels. In some embodiments, in the non-limiting example describe herein these areas would include distribution feeders in the valleys serving agricultural customers running large variable frequency drive (“VFD”) pumps, where the system monitors harmonics emissions from large agricultural and industrial customers helps detect and resolve harmonic issues. VFD pumps are also increasingly being used in pool and spa applications, and some embodiments can help monitor harmonic issues arising from them as well.

The amount of harmonics data generated from AMPQs increases with the number of AMPQs deployed in customer locations. This can result in a vast amount of data which would be impractical for power quality engineers to manually analyze. In some embodiments, the system includes analysis tools and process automation to help facilitate the analysis. In some embodiments, the harmonics data analytics executed by the system helps other businesses that can leverage the data to improve operational efficiency, reliability, and safety. For example, harmonics have been shown to negatively affect the operation of customer solar PV inverters.

In some embodiments, the disclosure is directed to a new way of leverage AMPQs to collect harmonics data in the electric distribution systems. In some embodiments, the AMPQ collects harmonics data comparable to power quality monitors at a lower cost since utilities already have electric meters installed at customer services for billing purposes.

In some embodiments, the system integrates harmonics and other power quality data into metering infrastructure in production environment. In some embodiments, the power quality data collected is used for power quality investigation, improving reliability, safety, efficiency, and customer satisfaction.

In some embodiments, the system is configured to identify harmonic distortion in a utility's electric distribution feeders. Investigation using the data provided by the system according to some embodiments revealed that the sources of harmonics in these areas are large variable frequency drives (VFDs) running agricultural pumps which have proliferated in recent years due to energy efficiency benefits. The drought conditions in California may have driven customers to install more and larger agricultural pumps to reach deeper water table. In many cases, these large pumps necessitate the use of VFD to allow the pump to start and run efficiently. However, VFDs also introduce significant harmonic distortion to the grid unless mitigation is taken.

In some embodiments, the AMPQ is configured to provide high-resolution harmonics data to support PQ investigation. As existing utility electric revenue meters do not collect harmonics data, in some embodiments, the system is configured to send program instructions to non-AMPQ smart meters to configure the smart meters to function at least in part as an AMPQ.

In some embodiments, a step includes the deployment of the AMPQs in the field. 125 distribution feeders across utility divisions were selected for harmonics monitoring according to some embodiments. In some embodiments, the 125 feeders were selected based on criteria such as feeders with high DER level, feeders with large industrials and commercial customers, feeders with high agricultural loads, feeders in rural areas and in urban areas etc., as identified by the system.

In some embodiments, a list of potential locations within the selected feeders was then created based on the following criteria: three phase service locations, meter form 9S, electrical service served from distribution transformer large than 750 kVA.

In some embodiments, in a first step the AMPQs were installed only in three phase service location and not in residential single phase service location. In some embodiments, most feeders had one AMPQ installed, and some feeders had a plurality of AMPQs installed to validate consistent harmonics readings in the feeder. In some embodiments, services larger than 750 kVA were chosen because they were more likely to have a large panel with spare meter socket available, whereas smaller services tended to have small panels that could not accommodate an extra electric meter. All the locations were inspected and pre-wired for the AMPQ. After installation, meter technician validated the meter program and tested 4G LTE connectivity before the AMPQs were ready for the project.

In some embodiments, the system includes an information technology (IT) system that automates the collection and processing of harmonics data from the AMPQs into utility cloud server and data analytics platform. In some embodiments, the system automatically performs daily reads of all the 180 AMPQs used in this non-limiting example, calculates harmonics statistics on a weekly basis, and then updates the Harmonics Dashboard. In some embodiments, the system also integrates other data streams from distribution equipment and existing revenue meters for data visualization and analysis.

In some embodiments, a third step was to create tools that help power quality engineer analyze the large amount of raw harmonics data including tools to automatically calculate statistical data for assessment and tools to perform correlation analysis between the harmonics and customer demands on the feeder to determine whether customers are causing harmonics.

In some embodiments, a step to correlate harmonics to customer demands includes the system acquiring real-time and historical data on customer power usage, including precise, time-stamped demand levels for each monitored segment or individual customer. Some embodiments include a step of the system then synchronizing the demand data with harmonic measurements, aligning time stamps to ensure accurate temporal correlation, so both data sets can be analyzed together within the same time intervals. Once synchronized, in some embodiments, the system segments the demand data by load patterns, identifying periods of peak and off-peak demand to categorize customer demand into profiles that reflect typical high or low consumption times.

In some embodiments, when the demand data is segmented, the system performs harmonic analysis independently for each demand profile, calculating metrics such as total harmonic distortion (THD) to assess how harmonic levels vary with different demand conditions. In some embodiments, the system then identifies specific correlations between harmonic distortion levels and demand patterns by comparing harmonic metrics across these profiles, which allows for pinpointing demand scenarios that most significantly influence harmonic levels in the network. In some embodiments, the system is configured to display an overview of harmonics in utility distribution network on the dashboard.

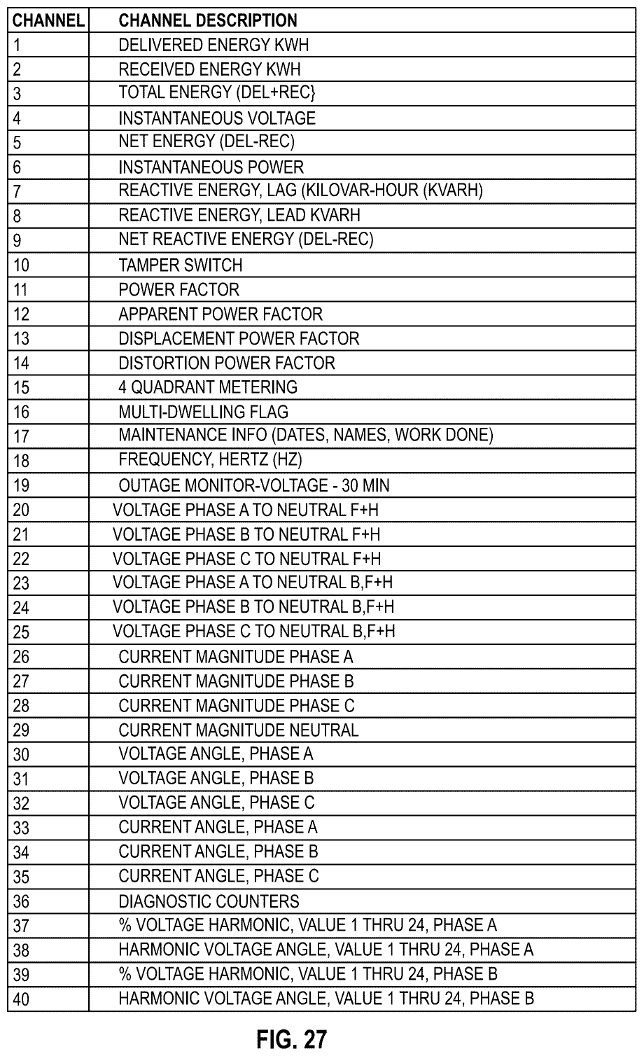

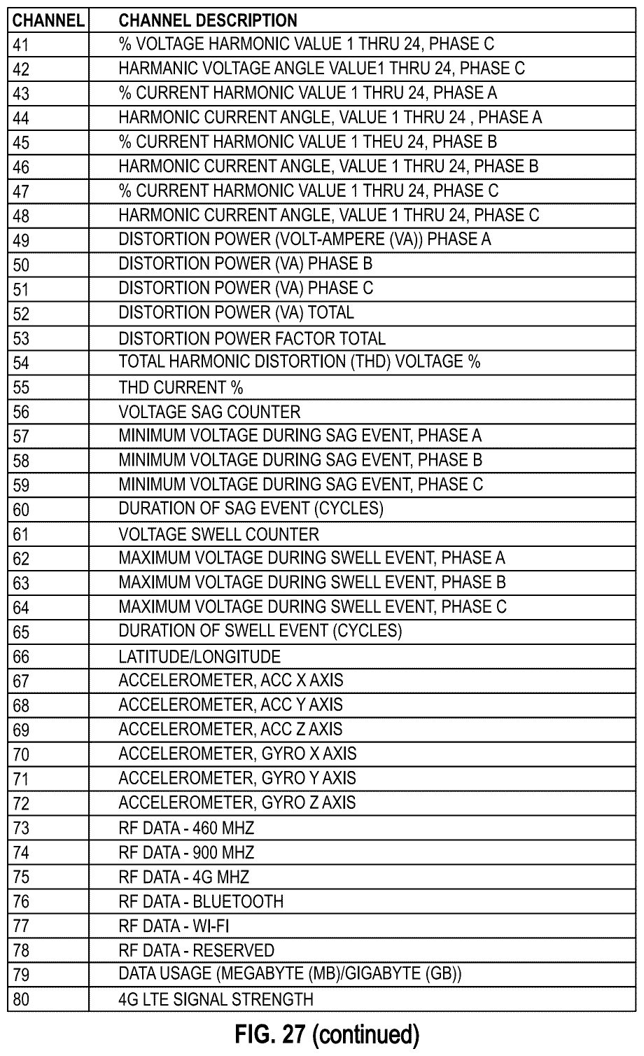

FIG. 27 shows a channel configuration for an AMPQ in accordance with some embodiments. In some embodiments, the AMPQ is configured to collect different load profile data over one or more channels (e.g., 64 channels). In some embodiments, the data collection interval can be programmed from 1 minute to 60 minutes, as non-limiting example, as any time period can be chosen. In some embodiments, to evaluate the harmonics data, the AMPQs were programmed to collect 12 channels of load profile data. In some embodiments, the data interval is chosen as 15-minutes to be consistent with the existing smart meter data intervals from commercial and industrial customers. In some embodiments, this facilitates the correlational calculations of the harmonics data from the AMPQs and the customer demand data.

Below is the list of some channels and descriptions of the data collected by the AMPQ.

TABLE 1
AMPQ meter channel and descriptions of data

| Channel | Description | Unit |
|---|---|---|
| 1 | Distortion VTHD Phase A - Max | % |
| 2 | Distortion VTHD Phase B - Max | % |
| 3 | Distortion VTHD Phase C - Max | % |
| 4 | Distortion ITHD Phase A - Max | % |
| 5 | Distortion ITHD Phase B - Max | % |
| 6 | Distortion ITHD Phase C - Max | % |
| 7 | Voltage Line to Neutral Phase A | Volts |
| 8 | Voltage Line to Neutral Phase B | Volts |
| 9 | Voltage Line to Neutral Phase C | Volts |
| 10 | Current Phase A | Amps |
| 11 | Current Phase B | Amps |
| 12 | Current Phase C | Amps |

In some embodiments, in addition to voltage and current data, the total voltage and current harmonic distortions (VTHD) and (ITHD) for each phase were collected. In some embodiments, no billing data such as power, demand, and energy consumption were collected by the AMPQs, although in some embodiments AMPQs are configured to collect billing data. In some embodiments, individual voltage and current harmonic frequencies were collected. A sample of harmonics spectrum analysis from the AMPQ showed the predominant harmonics in a utility's distribution systems are characteristically the 5th (300 Hz) and the 7th (420 Hz) harmonics. In some embodiments, each additional harmonic frequency includes six additional meter channels, three for each phase of voltage and three for current. In some embodiments, individual harmonics are enabled and collected on a case-by-case basis to provide more details of the harmonics in specific feeder locations.

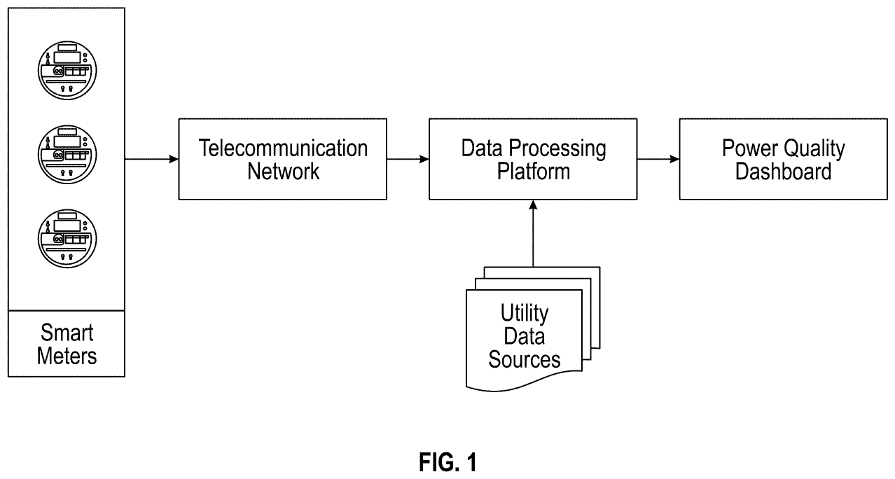

FIG. 1 shows the network infrastructure for harmonics data collection system according to some embodiments. In some embodiments, the system includes one or more smart meters and or AMPQs configured to send data to a data processing platform via a telecommunication network. In some embodiments, the data processing platform is configured to receive information from one or more utility data sources. In some embodiments, the data processing platform is configured to display one or more processing results on a power quality dashboard, as further described herein.

In some embodiments, the system includes one or more AMPQ. In some embodiments, the AMPQ includes an integral or coupled advanced electric meter capable of collecting power quality data such as harmonics data in addition to billing data. In some embodiments, the AMPQ is configured to communicate via a cellular network, and/or uses standard cellular LTE authentication mechanism to encrypt the cellular traffic with AES 128-bit encryption keys. In some embodiments, iPv4 private network addressing further increases data transfer security by using additional VPN security mechanism using utility Peering Routers.

In some embodiments, the system includes a virtual machine server. In some embodiments, the server runs the meter software and a meter data collector application. In some embodiments, the meter application is configured to communicate with the AMPQs over 4G LTE and download harmonics data from the AMPQ meters periodically (e.g., daily). In some embodiments, the meter software also converts the native AMPQ meter data half-hour files (HHF) files into CSV files and the data is stored on a local shared drive of the server. In some embodiments, enhanced secure file transfer eSFT agent is configured to access the shared drive on an hourly basis and copied the files to eSFT server. In some embodiments, an agent (e.g., Foundry Agent) is configured to copy the files and store the files into a data integration and analytics platform (e.g., Foundry®) dataset for further processing.

In some embodiments, the system includes Palantir Foundry®, which includes a utility enterprise data platform which supports data visualization and analytics. In some embodiments, the harmonics dashboard is created on the Foundry platform. In some embodiments, the Foundry Agents are deployed at OneCloud and integrate with utility IT systems for collecting raw data and forward the collected data to backend Foundry infrastructure which are deployed at Amazon Web Services® (AWS) Cloud.

In some embodiments, the system includes an electrical distribution planning interface (EDPI) platform which houses data from SCADA-enabled electric distribution line devices such as feeder loads information. In some embodiments, in addition to the AMPQ harmonics data, feeder circuit breaker and line recloser data are used for the harmonic data analysis. In some embodiments, the foundry platform retrieves line recloser and circuit breaker loads data from EDPI and transfer them to Foundry platform periodically (e.g., on a weekly basis). Non-limiting EDPI functionality executed by the system includes the ability to simulate various operational scenarios and assess how changes in the distribution network (such as adding or removing loads, altering power sources, or upgrading infrastructure) will impact the overall performance of the grid. In some embodiments, the EDPI is used by the system for integration of data from various sources that include the SCADA, smart meters, geographic information systems (GIS), and advanced metering infrastructure (AMI).

In some embodiments, the system is configured to predict future electricity demand, identify areas of the grid that may become overloaded or underutilized, monitor grid health, and identify fault location, modeling how alternative energy variable sources of power interact with the grid and impact distribution networks.

In some embodiments, the system includes a high-performance, scalable data analytics and data warehousing platform (e.g., Teradata®) which houses customer data. In some embodiments, customer demand data is used in correlational analysis with harmonics data from the AMPQs to determine if any customers may be causing harmonics. In some embodiments, the Foundry platform, for example, retrieves customer demand data from Teradata periodically (e.g., on a weekly basis).

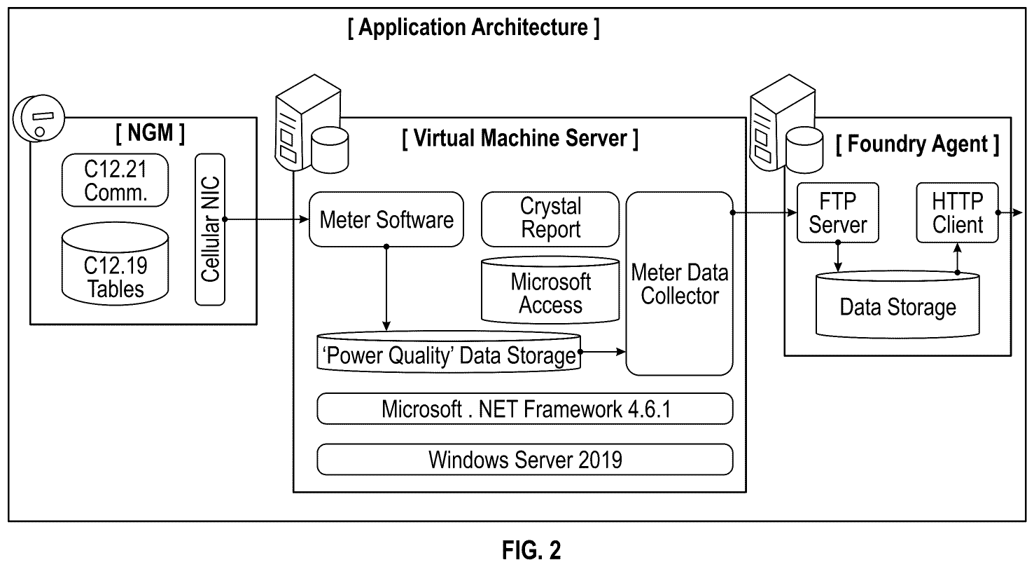

FIG. 2 shows an application interface diagram according to some embodiments. In some embodiments, the meter software reads meter data on the C12.19 table. In some embodiments, the data collector application is developed using python codes to trigger the daily AMPQ meter data collection, reset meter load profile data, and/or convert HHF files into comma-separated values (CSV) meter data files. In some embodiments, the CSV data files are then copied into Foundry platform for further processing and analysis. Users can then access the harmonics data and interact with the harmonics dashboard on Foundry via an HTTP browser.

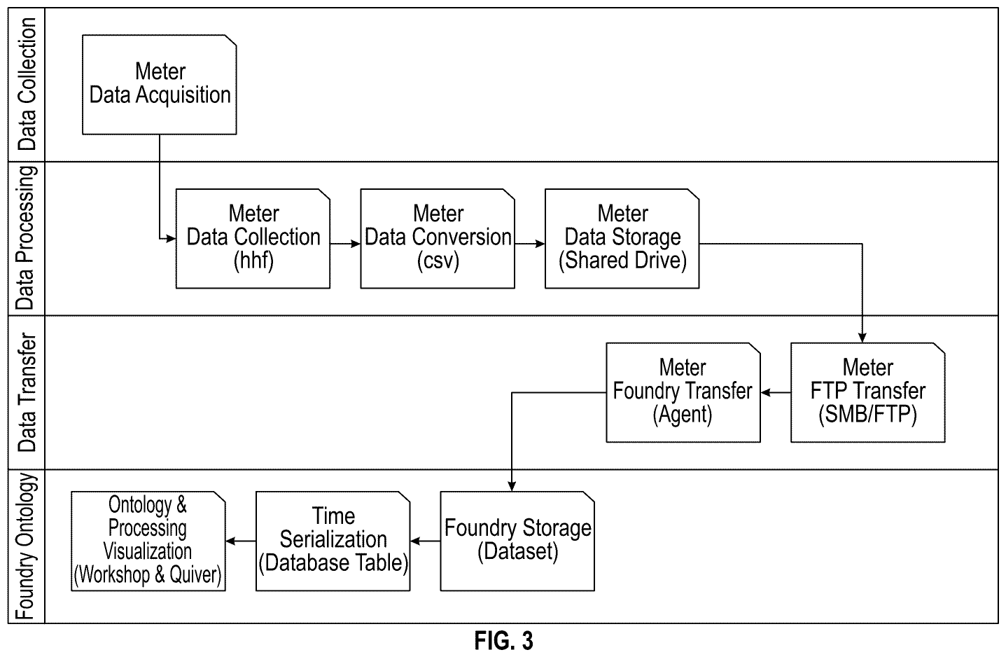

FIG. 3 shows a meter data flow diagram according to some embodiments. In some embodiments, the data visualization and analysis is not a real time application. In some embodiments, the data server does not collect, transfer and store data in real time. In some embodiments, the data server pulls, processes and stores data from different sources periodically (e.g., daily). In some embodiments, the data is made available on the harmonics dashboard, which is updated periodically.

In some embodiments, the AMPQ harmonics data is imported and stored in Foundry platform by the system. In some embodiments, several calculations are performed as described herein. In some embodiments, the calculations of the harmonics data are performed on a periodic (e.g., weekly) basis. Any timeframe described herein is a non-limiting example that may be replaced with “periodically” or some other generic term when describing the metes and bounds of the system.

In some embodiments, at meter level, for each AMPQ data set, the average, minimum and maximum values of the Voltage Total Harmonic Distortion (VTHD) and Total Current Harmonic Distortion (ITHD) time series are calculated by the system and/or displayed on the harmonics dashboard. In some embodiments, the 95th percentile values are also calculated for statistical analysis. In some embodiments, the 95th percentile value of the VTHD is then compared to IEEE 519 voltage distortion limit which is 8.0% for system voltage below 1,000V. In some embodiments, if the 95th percentile value exceeds 8.0%, then the AMPQ location and the distribution feeder where the AMPQ is installed are considered to have harmonic issues. The actual distortion limit may vary between systems, but 8% was choses for this non-limiting example.

Table 2 shows IEEE 519 Voltage distortion limits according to some embodiments.

| | Individual | Total harmonic |
|---|---|---|
| Bus voltage V at PCC | harmonic (%) h ≤ 50 | distortion THD (%) |
| V ≤ 1.0 kV | 5.0 | 8.0 |
| 1 kV < V ≤ 69 kV | 3.0 | 5.0 |
| 69 kV < V ≤ 161 kV | 1.5 | 2.5 |
| 161 kV < V | 1.0 | 1.5^{a} |

In some embodiments, the results are produced by the system to flag where any location in a distribution feeder has harmonic issues. In some embodiments, other calculations include the percentage of time that the VTHD exceeds a limit (e.g., IEEE 519) for a given meter location. In some embodiments, the total system harmonics health indicator value is also calculated by taking the number of all the VTHD readings that are within IEEE 519 limit and divided by the total number of VTHD readings, so that a value of 100% means that none of the VTHD readings from all AMPQs during the last one-week period exceeds IEEE 519 limit.

In some embodiments, the system is configured to execute feeder harmonics and customer demand correlation calculations. Power quality investigations show that the harmonics in the utility system primarily come from customers' loads. In some embodiments, one or more analysis tools described herein and/or associated with the platforms described herein is configured to identify customer locations that may be injecting harmonics into the distribution systems. In some embodiments, the harmonics dashboard calculates the strength of correlation between the VTHD time series from the AMPQ and the demand of individual customers located on the same distribution feeder in the same time frame.

In some embodiments, the calculation results in a Pearson correlation coefficient value for each individual customer. In some embodiments, a pre-determined value (e.g., 0.5 to 1.0) means a large correlation, where the customer may likely contribute significantly to VTHD increase in the distribution system. In other words, when this customer's loads come online, the VTHD also increases in lockstep, and when the customer's loads go offline, the VTHD also decreases. In some embodiments, for a medium correlation coefficient value (e.g., 0.3 to 0.5) the system is configured to suggest a medium correlation, and a small value (e.g., 0.1 to 0.3) indicates a small correlation, respectively. In some embodiments, the harmonics-customer demand correlation calculation in this non-limiting example includes three-phase customers who are designated agricultural, commercial, and industrial account and who are served from service transformer larger than 300 kVA.

As describe above, in some embodiments, the system includes a harmonics dashboard that power quality engineers can use to monitor and investigate harmonics in utility distribution systems. In some embodiments, the harmonics dashboard includes the Palantir Foundry platform to facilitate visualization and analysis of harmonics data from the AMPQs. In some embodiments, the harmonics dashboard display includes one or more of the following sections: summary, list of all AMPQs, AMPQ level details, feeder level details, harmonics correlation to customer demand, and details of harmonics correlation to customer demand.

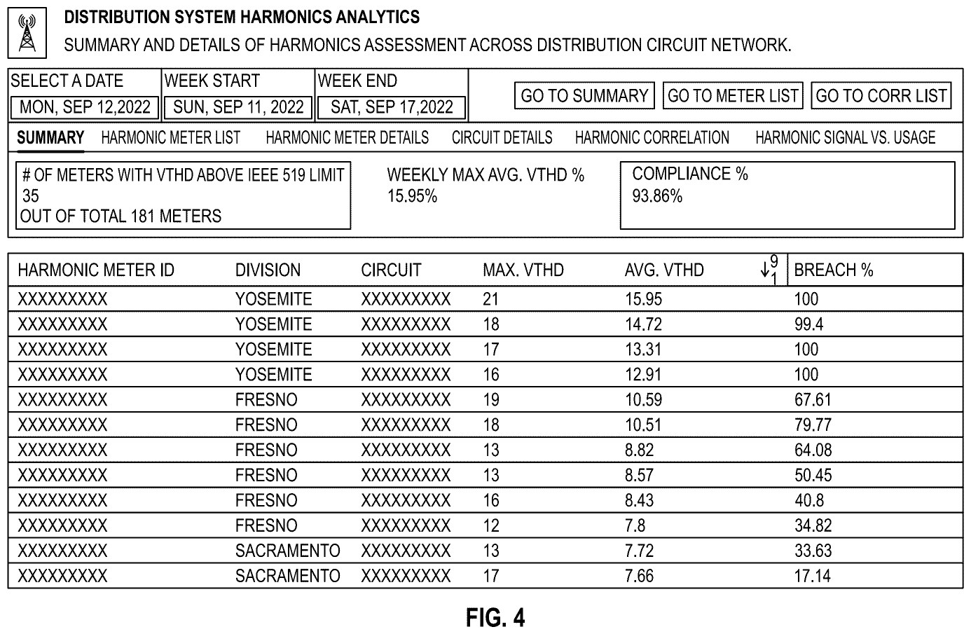

In some embodiments, the summary tab displays an overview of the harmonics data from one or more of the installed AMPQs. In some embodiments, the summary tab displays periodic (e.g., weekly) data and calculations such as the number of AMPQs reporting VTHD level above (IEEE 519) limit, the average VTHD level, and a metric to track harmonics performance. In some embodiments, the summary tab shows a list of all the AMPQs that report VTHD level exceeding the IEEE 519 limit including the divisions and feeders where they are located. In some embodiments, the summary tab is configured to give an overview of the harmonics in the system weekly and flags locations where high harmonics level may be occurring. FIG. 4 illustrates a non-limiting harmonics dashboard according to some embodiments.

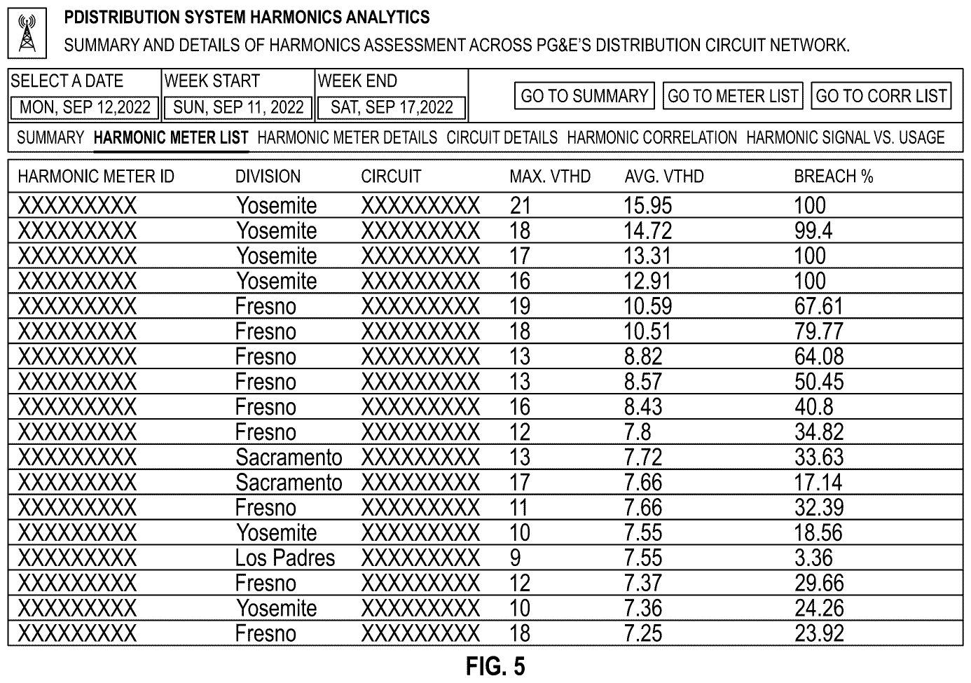

In some embodiments, the Harmonic Meter List tab displays a list of one or more AMPQs and details including meter ID, division, feeder and VTHD data. In some embodiments, the list can be sorted by the level of VTHD, division, and feeders. In some embodiments, the harmonics data on this tab include maximum VTHD, average VTHD and the percentage of the time the meter reports VTHD exceeds IEEE 519 limits during the week. In some embodiments, from this page, individual AMPQ can be selected to display further meter level details. FIG. 5 shows a list of AMPQs according to some embodiments.

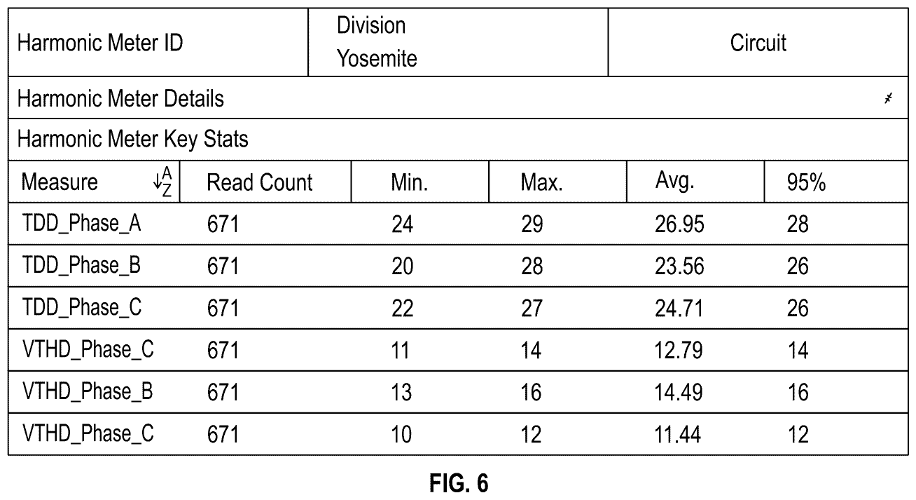

In some embodiments, the Harmonic Meter Details tab displays harmonics data for selected AMPQ such as VTHD and Current Total Harmonic Distortion (ITHD) for each phase and 95th percentile values and time series charts of the parameters during the week. FIG. 6 shows meter level details according to some embodiments.

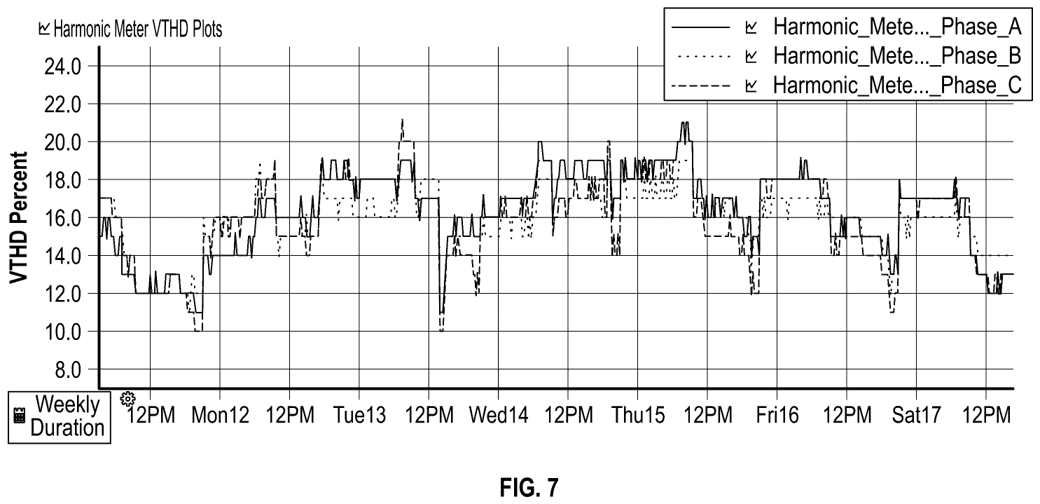

In some embodiments, The VTHD time series chart shows VTHD trend for the AMPQ location over the week. In some embodiments, the system is configured to identify harmonics patterns for use in correlation analysis with other data sets such customer demand and feeder loads. FIG. 7 shows a VTHD time series chart according to some embodiments.

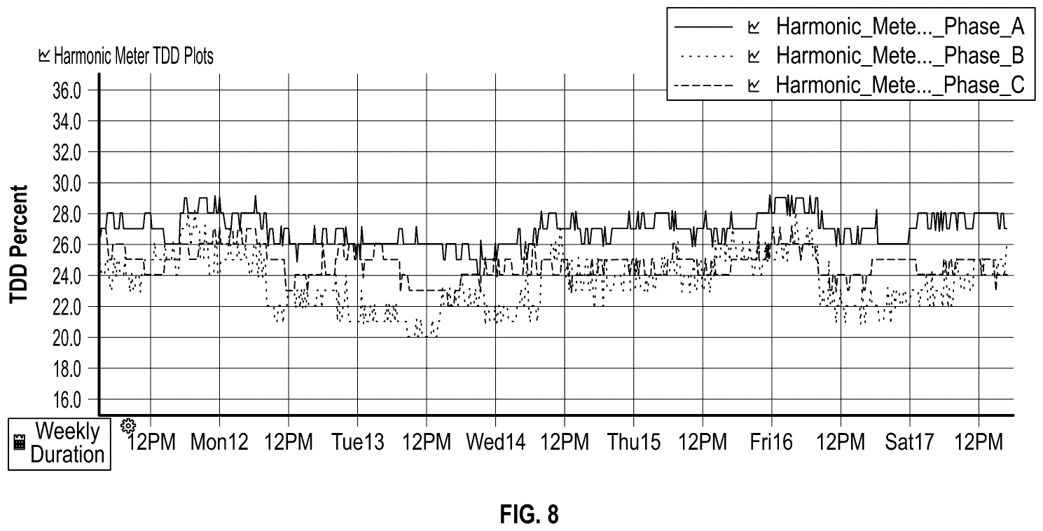

In some embodiments, the ITHD/TDD time series chart gives an idea of how much harmonic current distortion is coming from the customer where the AMPQ is installed. In some embodiments, the ITHD/TDD can also be assessed per the IEEE 519 recommended limit. The focus in this non-limiting example according to some embodiments was on the VTHD to get a picture of the voltage quality provided by the utility to customers. FIG. 8 shows an ITHD/TDD time series chart according to some embodiments.

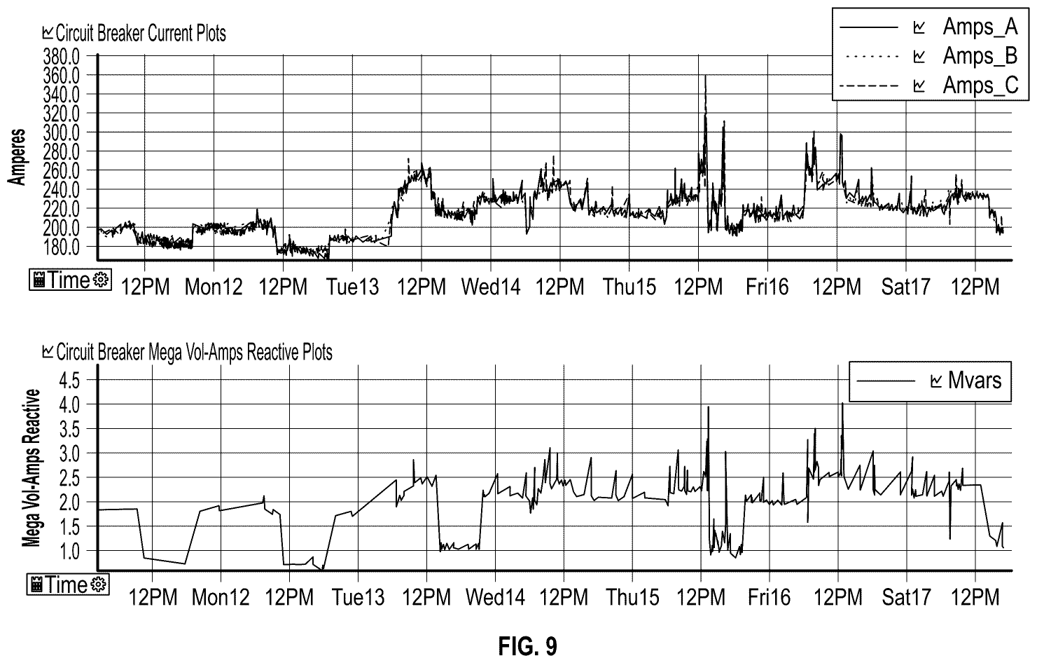

In some embodiments, the system is configured to display Feeder level details. In some embodiments, the Circuit Details tab displays time series chart for feeder loads from feeder circuit breaker and line recloser(s) on the feeder. In some embodiments, together with the VTHD time series from the AMPQ, the circuit breaker amps and VAR time series can help determine if the harmonics level on the feeder correlates to overall loads on the feeder and that the harmonic distortion on the feeder is caused by customers' loads. FIG. 9 shows feeder circuit breaker amps and VAR reactive power according to some embodiments.

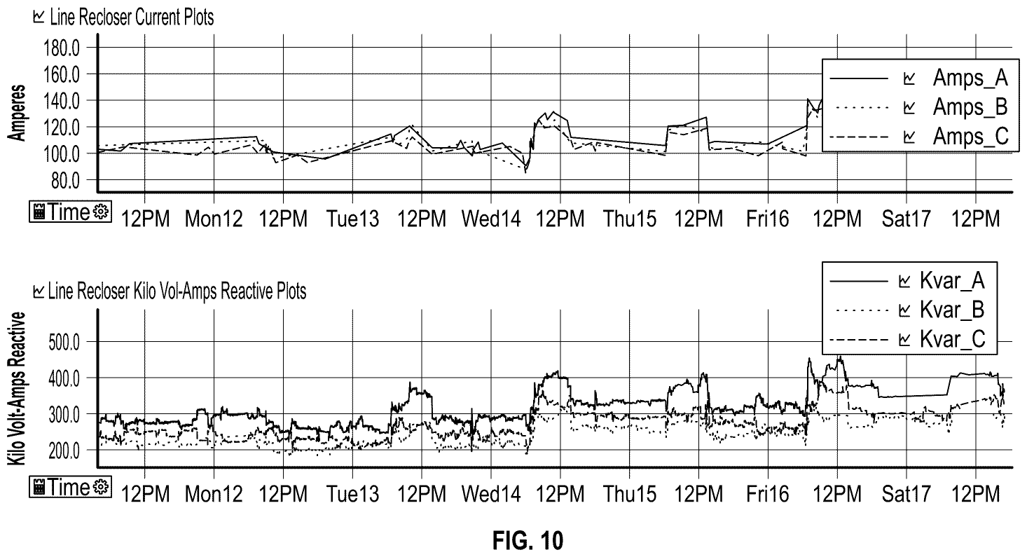

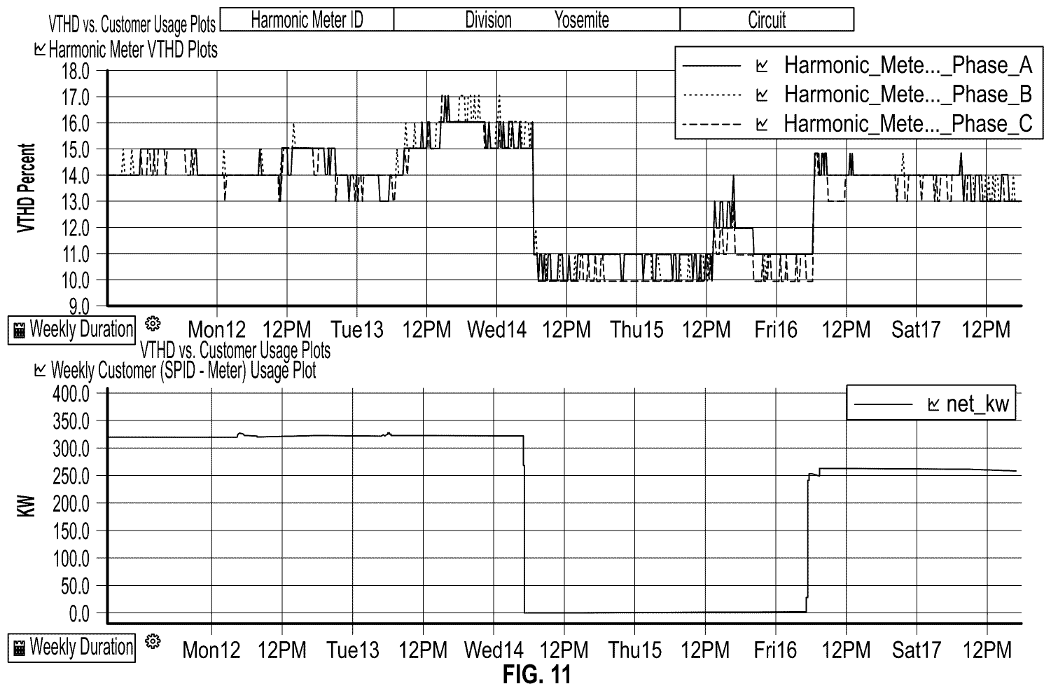

In some embodiments, the amps and VAR time series from line reclosers on the feeder can help determine section(s) of the feeder where harmonics-producing loads are located. In some embodiments, this depends on the number of available line reclosers and their locations on the feeder. In some embodiments, for example, if the voltage harmonics on the feeder correlates to loads downstream on a line recloser but not on another line recloser, the loads downstream on the first line recloser may be rich in harmonic current which distorts the feeder voltage as it flows back to the substation. FIG. 10 depicts Feeder line recloser amps and VAR reactive power according to some embodiments.

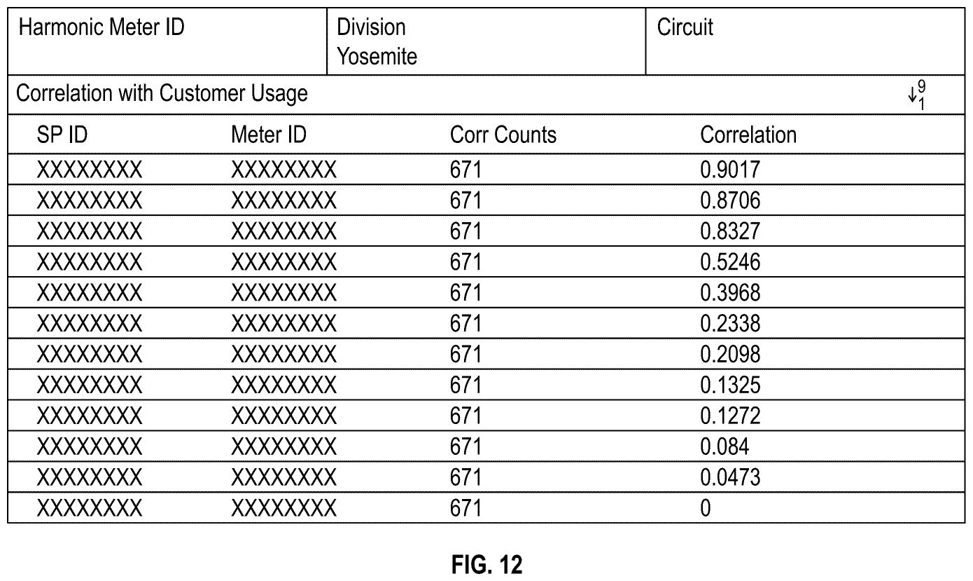

In some embodiments, the system is configured to correlate harmonics to customer demand. In some embodiments, the system is configured to be an analysis tool that helps power quality engineers investigate harmonics, specifically to help determine potential sources of harmonics, which at the time of this disclosure was difficult because harmonic distortion on distribution feeders were primarily caused by non-linear loads. The non-limiting example described herein looked at the correlation between the VTHD trends from the AMPQ and customer demand trends on the same feeder during the same period of one week, however, in some embodiments, the system is configured to analyze any time period (e.g., 5 years). FIG. 12 shows a list of customers on the feeder and their corresponding harmonics correlation score according to some embodiments. In some embodiments, on this dashboard page, individual customer can be selected to display the VTHD and the customer demand time series side-by-side for comparison as shown in FIG. 11.

As described above, in some embodiments, the AMPQs are installed separately alongside the existing revenue meters already installed at customer meter panels to limit impacts on the billing system. In some embodiments, the system includes a meter panel with a spare meter socket. Some embodiments include a dual-socket meter adapter for the AMPQs installation.

In some embodiments, the harmonics data collection system includes several data pipelines that were created to bring data from both the AMPQs and other electric distribution devices and/or existing smart meters. In some embodiments, these different datasets need to be processed and synchronized by the system to provide data visualization and run calculations for the harmonics dashboard.

In some embodiments, the system includes an alert mechanism configured to report any issues with the data pipelines at each stage of data processing. In some embodiments, the system is configured to provide a (daily) report for data download and process to provide alerts when there were issues with the data pipelines, so that the problems can be detected and fixed as quickly as possible.

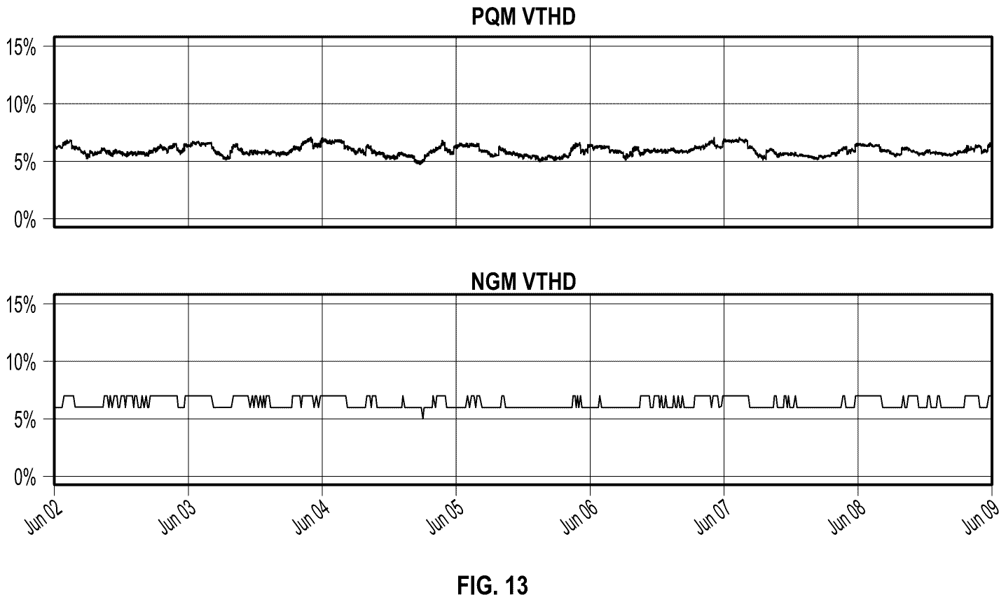

In some embodiments, the system is configured to display AMPQ Harmonics Data. FIG. 13 shows a comparison between the voltage total harmonic distortion (VTHD) data from the AMPQ and from a traditional PQM that was installed at the same location according to some embodiments. The data from both devices show similar readings. However, there were some differences: the AMPQ harmonics data was 15-minutes interval while the PQM data interval was one minute; the data from PQM are much more granular; the VTHD readings from the AMPQ is rounded up to the nearest integer whereas the VTHD readings from the PQM contain two decimals: the PQM provide more data precision in this non-limiting example, however, some embodiments include configuring a smart meter to function as an AMPQ with the same resolution as a PQM.

In some embodiments, the AMPQ is programmed to collect harmonics data at 15-minutes intervals in this non-limiting example to facilitate easy computation of correlation coefficient between the AMPQ harmonics data and customer demand data from utility existing revenue meters, which are collected at 15 minutes interval for commercial and industrial customers. It was found that the correlation coefficient calculation was more accurate when both datasets were synchronized on the same time interval.

In some embodiments, the AMPQ can be programmed to collect data at any interval from 1 minute to 60 minutes allowing for flexibility if more granular data is required. Regarding the precision of the data, the harmonics data from the AMPQ is not as precise as PQM data. However, the data is sufficient for the purpose of measuring general level of harmonics and detect when the harmonics in the systems are changing, and less expensive as previously explained.

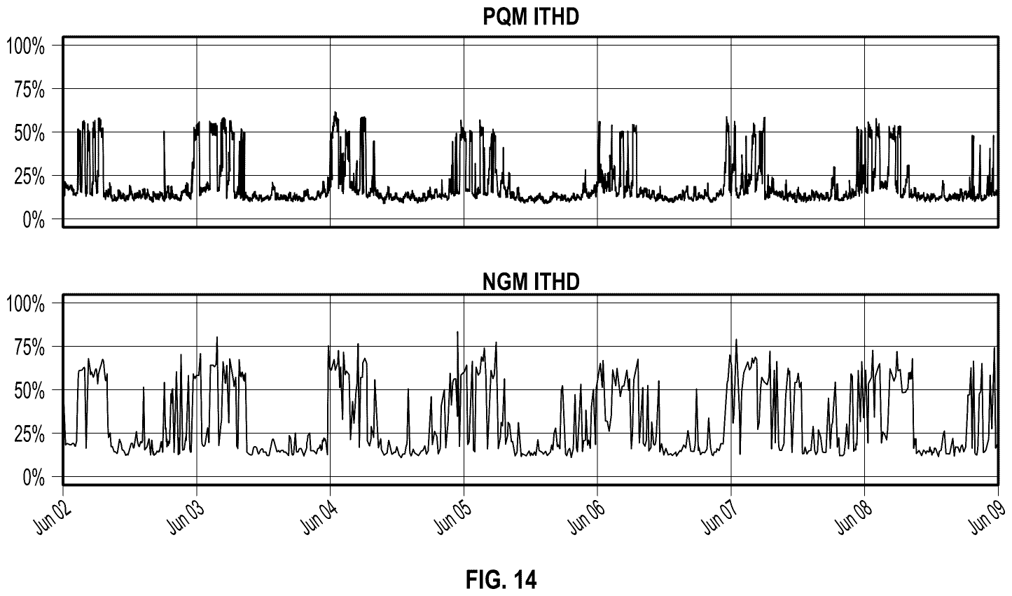

In some embodiments, the current total harmonic distortion (ITHD) data from the AMPQ is also compared with the data from PQM in FIG. 14. The results show the ITHD data from both devices are comparable. Again, the AMPQ data is not as granular and precise as the PQM data, but it is sufficient for preliminary assessment of customers' harmonic loads. The data comparison shows that the AMPQ can collect reliable harmonics data which could replace the need to use PQM in most cases.

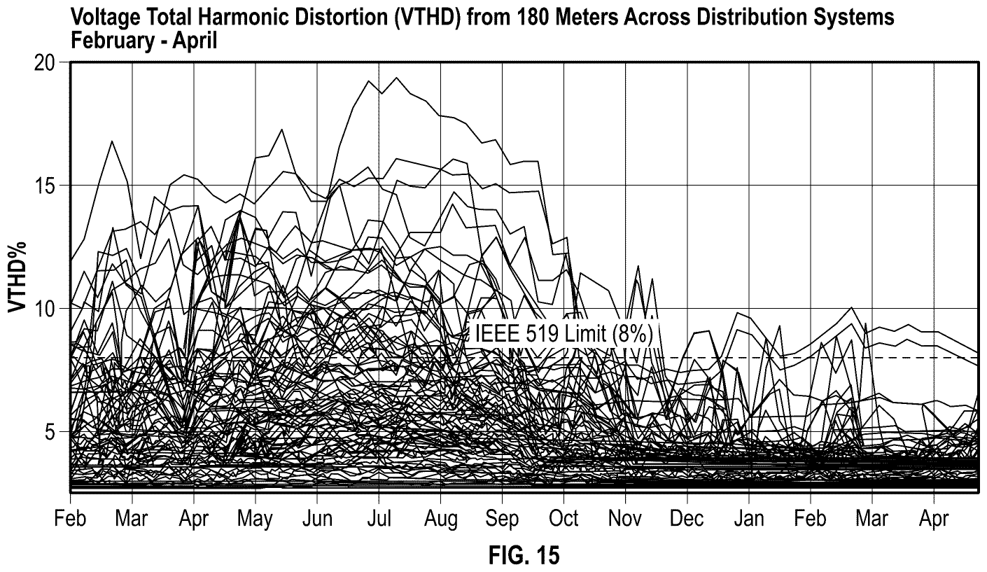

In some embodiments, the system is configured to display overall voltage harmonics results according to some embodiments. FIG. 15 shows the VTHD time series charts from 180 AMPQ locations according to some embodiments. The VTHD readings range from 2% up to 20% for some meters. The results in this figure suggest that the majority of the AMPQ locations are showing VTHD readings below the IEEE 519 limit of 8% as represented by the thick lines on the bottom portion of the chart. For the AMPQ locations that show VTHD exceeding IEEE 519 limit, they exceed the limit by a significant margin. In some cases, the VTHD reading by the system are as high as 15-20% on some locations, which means the voltage harmonic distortion on these feeders is severe and more likely to cause issues for customers' equipment. The level of harmonics directly correlates to the loads in the distribution system, specifically, the loads in agricultural feeders during irrigation season in this non-limiting example.

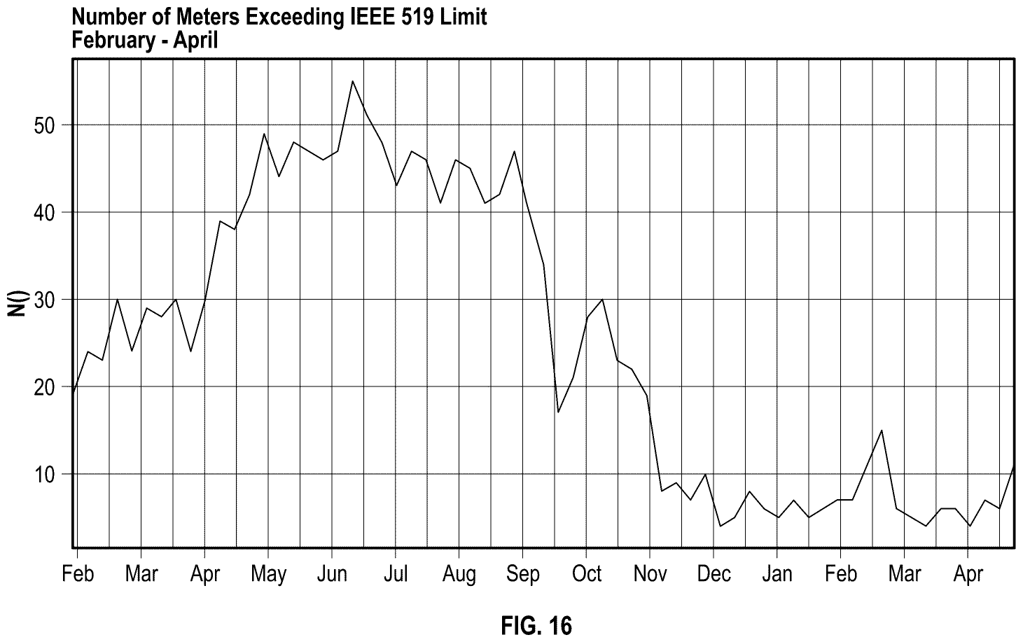

In some embodiments, the system is configured to display meters and feeders level numbers as a function of time. FIG. 16 depicts the number of AMPQs with VTHD readings exceeding IEEE 519 limit on a weekly basis according to some embodiments. The number ranges from 5 meters to up to 55 meters out of 180 meters installed. This was determined by calculating the 95th percentile of the VTHD interval readings over a period of one week according to some embodiments and comparing the calculation to the IEEE 519 limit of 8% for this network. The results according to some embodiments show that the number of AMPQs with high voltage harmonics readings significantly increased in April and stayed high through the summer months before falling in November.

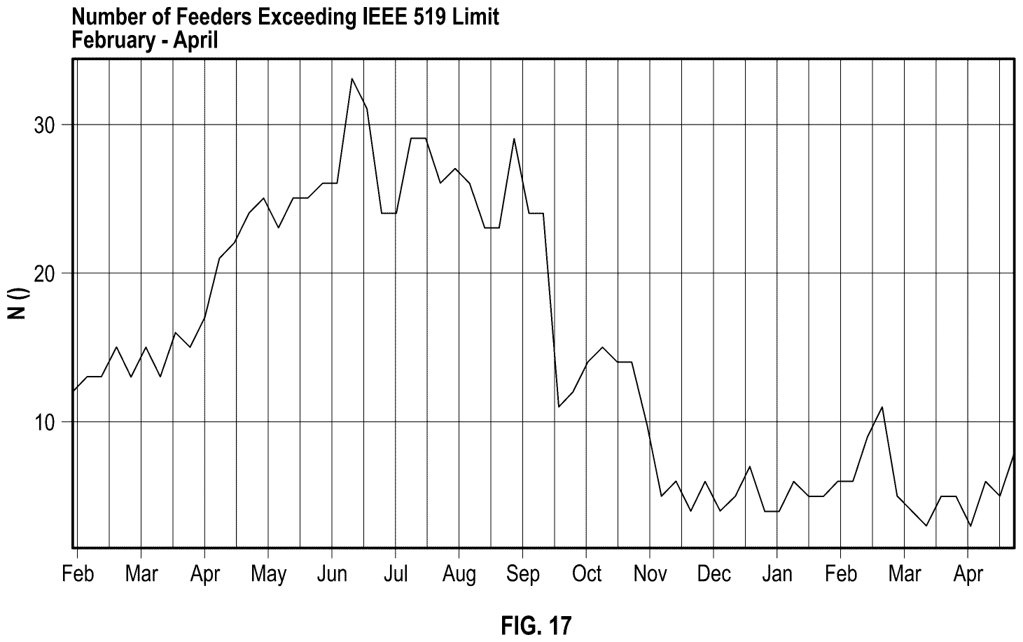

FIG. 17 illustrates the number of feeders that have AMPQs reporting VTHD higher than IEEE 519 limit according to some embodiments. The chart shows a similar trend to FIG. 16. The number of feeders with high harmonics readings ranges from 4 up to 33 feeders out of 125 feeders monitored. However, the numbers are smaller because some feeders had more than one AMPQ installed as part of the system configuration.

In some embodiments, some feeders have multiple (e.g., 3-4) AMPQs installed to validate whether the VTHD is high across the feeder or only in isolated locations. The results show that on feeders with high VTHD, the VTHD seems to be elevated across the feeders and vary by a few percentages. Therefore, the voltage harmonic distortion is likely seen by all customers on the feeder.

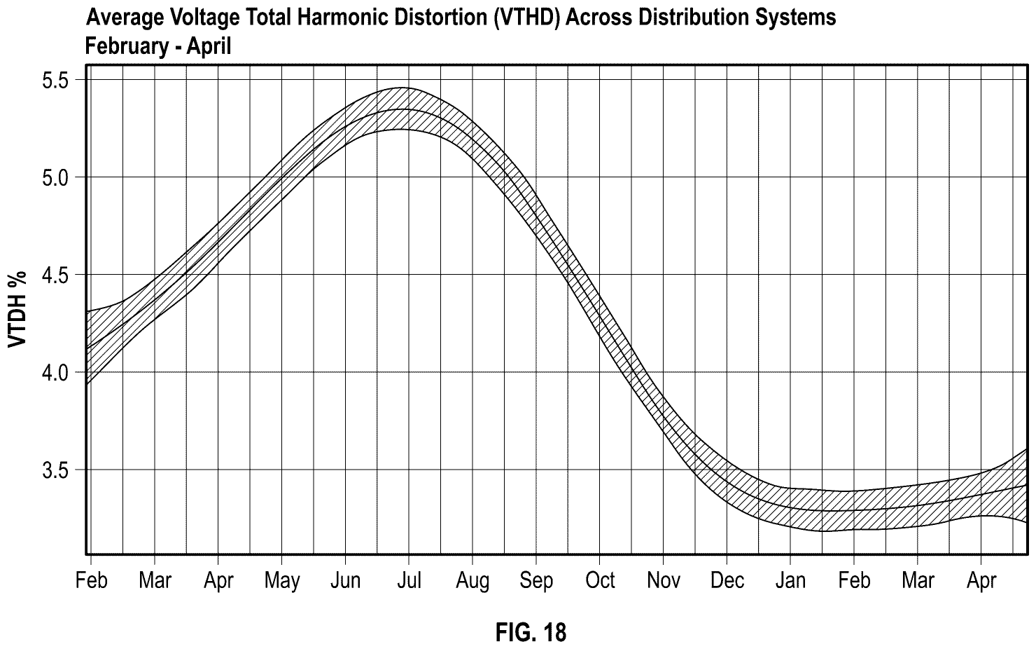

In some embodiments, the system is configured to display harmonics in terms of seasonality. The aggregated average VTHD from all the AMPQs is shown in FIG. 18. The trend shows that the harmonics level in the systems increases from spring and peaks in July before declining in late fall. The findings suggest that harmonic issues in utilities are seasonal and appear to correlate to seasonal loads in the distribution systems. The system revealed the distribution system voltage harmonics increases in lockstep with seasonal loads in feeders that have high level of agricultural loads. Most harmonics in these feeders come from large VFDs running agricultural pumps. These VFD pumps can be quite large ranging from 100-500 horsepower and the harmonics output from them add up on the primary voltage of the distribution system causing signification deterioration of the service voltage quality. From the harmonics data obtained by the system, the results show that the increase in harmonics directly corresponds to the start of the irrigation season typically around March and April, and then the harmonics subsides when the irrigation season ends in October and agricultural customers turn off their VFD irrigation pumps.

No single customer was responsible for the harmonic distortion on the feeder in this non-limiting example. The harmonics were an aggregation of many dispersed harmonics sources on the feeder, especially because the VFDs did not have any harmonic filter installed to limit their harmonics output. In some embodiments, a method includes installing a harmonic filter at the area(s) identified by the system. In this non-limiting example, the system showed that the number of AMPQs with high harmonics readings remains relatively low in April 2023 compared to the previous year. This is because California has received much rainfall in the winter of 2022-2023 which delayed the start of the irrigation season in 2023. In some embodiments, the system is configured to predict an increase in harmonic distortion. According to the analysis for this example, the harmonics level is expected to climb in the summer as soon as the irrigation season starts.

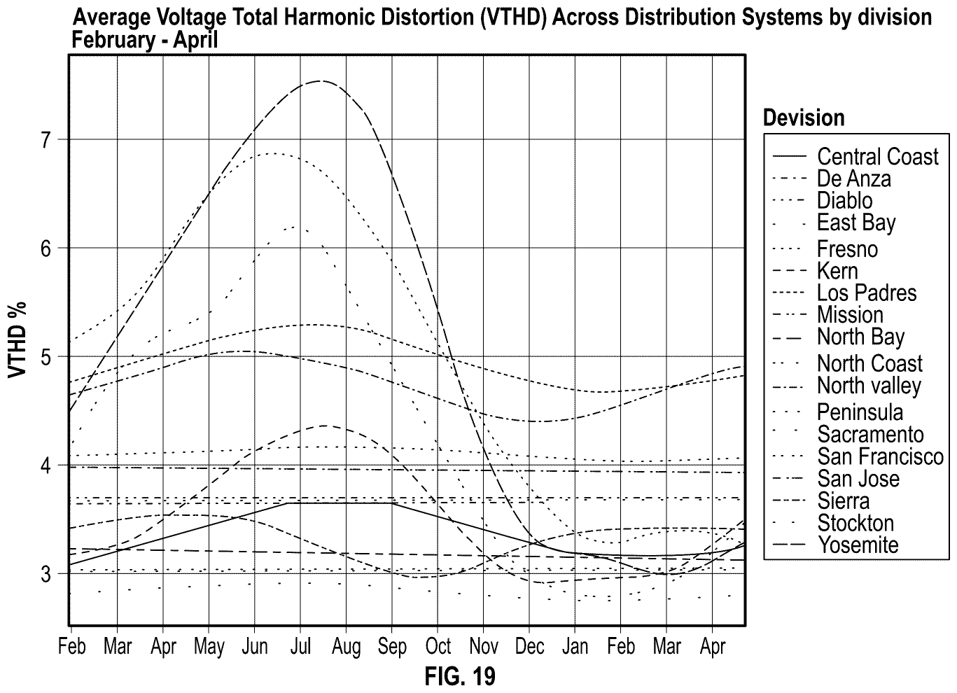

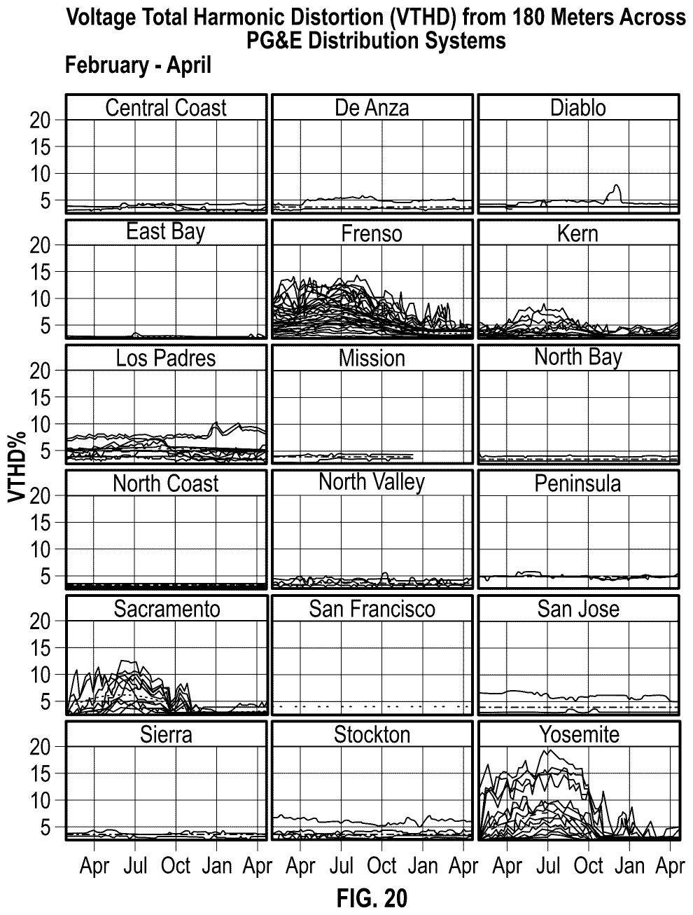

When a standard 6-pulse VFD operates without any harmonics mitigation, the VFD does not draw current linearly, and therefore is creating current harmonic distortion which in turn results in voltage harmonic distortion in the utility distribution systems. One of the characteristics of the feeders chosen for monitoring in these divisions is that they are considered agricultural feeders because they serve many agricultural customers and are in farmland. FIG. 19 depicts average VTHD readings by division generated by the system according to some embodiments. FIG. 20 shows VTHD readings by divisions generated by the system according to some embodiments.

Feeders with small number of VFDs may not experience harmonic issues. However, the harmonics from these VFDs are additive. In feeders where there are a lot of VFDS, the harmonics are adding up in the distribution systems and can results in severe harmonic distortion of the voltage waveform that utility provides to all customers the feeder, which may then impact customers if their equipment is sensitive to harmonics. In some embodiments, the system includes mitigations for VFD are available in the industry including harmonics filters and VFD with harmonics mitigating design such as VFD with active frontend, 12-pulse and 18 pulse VFD etc. In some embodiments, a method step includes to install harmonic filters at agricultural locations.

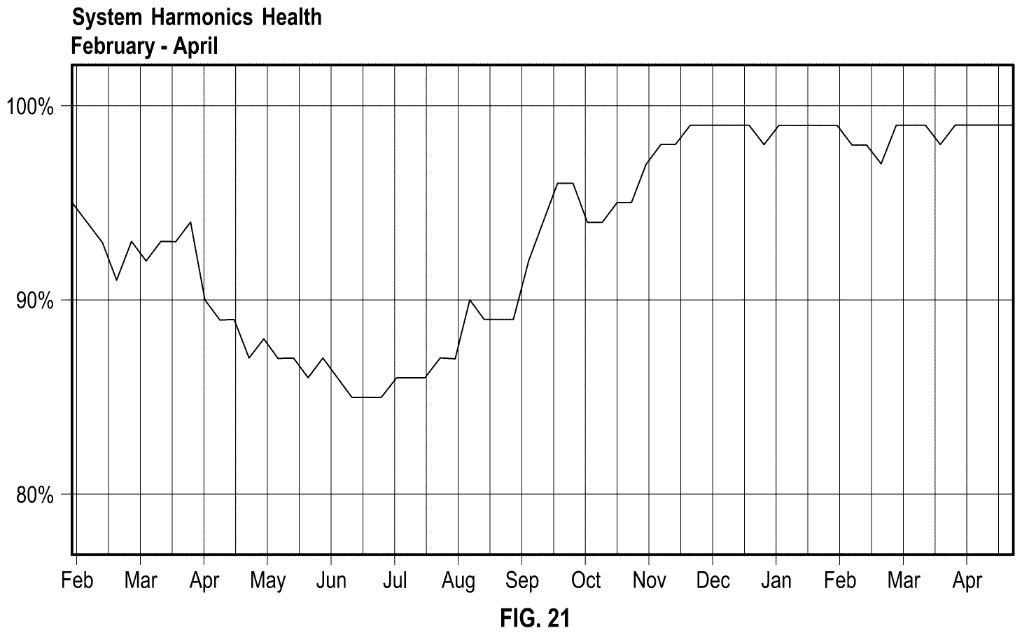

In some embodiments, the system is configured to display harmonics monitoring results. In some embodiments, the harmonics dashboard displays a key performance indicator used to monitor the overall harmonics. In some embodiments, the key performance indicator is based on aggregated VTHD readings from all the AMPQs assessed per IEEE 519 limit. FIG. 21 depicts the health of the systems from harmonics perspective which is about 85% at the lowest point in the summer and about 98-99% in the winter and spring according to some embodiments.

In some embodiments, the system is configured to generate a correlation of feeder voltage harmonics and feeder loads. In some embodiments, for harmonics analysis, the harmonics dashboard also imports SCADA data from feeder circuit breaker (CB) and feeder line reclosers (LR). The harmonics data from the AMPQs and SCADA data show that there is a very strong correlation between the feeder loads and voltage harmonics level, further supporting the findings that most voltage harmonics in utility distribution systems are caused by loads, specifically certain type of loads such as VFDs. By looking at the feeder loads from CB and LRs, in some cases it is possible to determine the general area where most of the harmonic's sources are located on the feeder.

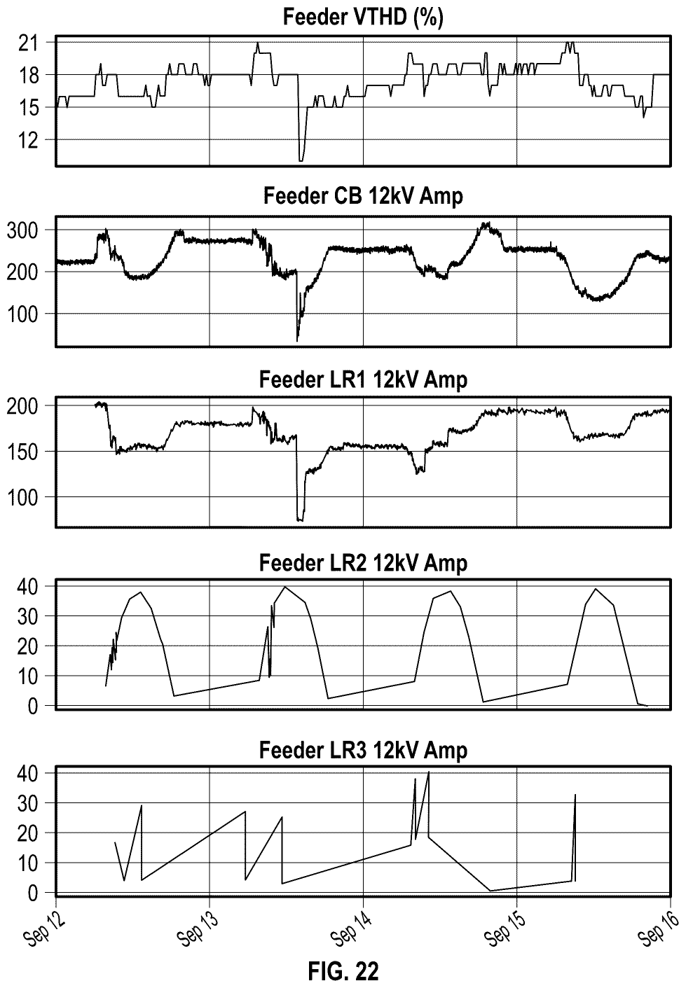

FIG. 22 shows an example of comparing feeder VTHD variation with the feeder loads from CB and LR according to some embodiments. It is seen that the VTHD drops sharply on September 13th when the CB loads drop suggesting that the harmonics is caused by loads. Looking at the loads on the three LRs on the feeder, the loads of LR1 strongly correlates to the VTHD on the feeder suggesting that the sources of harmonics are located on the load side of LR1 whereas the loads on LR2 and LR3 does not show any correlation. The loads pattern of LR2 is typical of a solar generation profile which may reduce the overall VTHD on the feeder because the solar generation masks the demand from harmonics-producing loads, thus reducing harmonic current flowing back to a utility source. In some embodiments, the harmonics data from the AMPQ and SCADA data help utility power quality engineers to conduct a preliminary assessment of where the harmonics come from by identifying areas of concern.

As mentioned previously, in some embodiments, the system is configured to execute a correlation of feeder voltage harmonics and customer demand. In some embodiments, the system includes an analysis tool that help power quality engineer investigate harmonics. In some embodiments, the system is configured to identify which customers are be injecting excessive harmonics into the systems. In some embodiments, using VTHD trend from the AMPQ as a reference for the feeder harmonics level, an algorithm implemented by the system is configured to generate a correlation coefficient value between each customer's demand trend and the VTHD trend during a weekly data calculation timeframe. In some embodiments, the output includes a list of customers on the feeder and their corresponding harmonics correlation “score”.

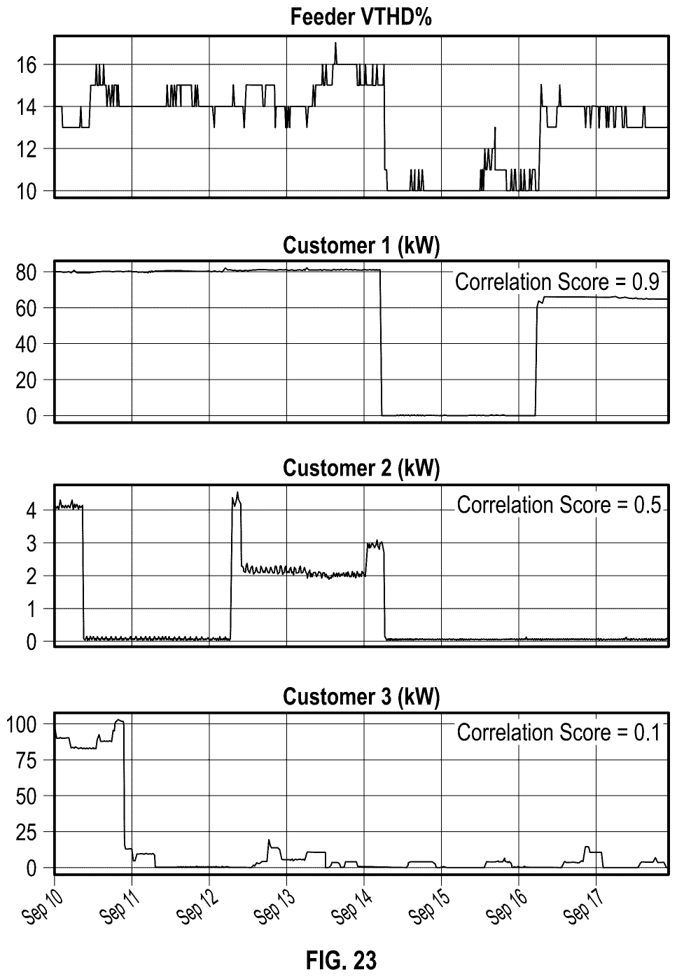

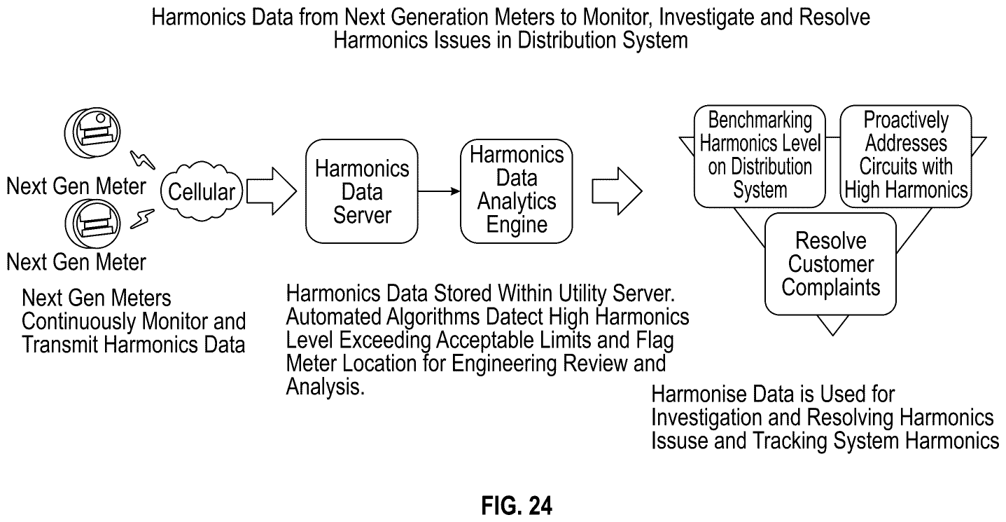

FIG. 23 shows an example of feeder harmonics and different values of customer demand correlation score according to some embodiments. In some embodiments, customer 1 demand with correlation score of 0.9 shows a very strong correlation to feeder harmonics variation. When Customer 1 loads go offline, the feeder VTHD decreases and when Customer 1 loads come online, the feeder VTHD increases in lockstep. This suggests that Customer 1 may have electrical loads that inject significant harmonics into the system. Customer 2 demand with correlation score of 0.5 shows relatively smaller correlation and the demand is very small. Customer 2 loads do not appear to be a major source of harmonics. Customer 3 demand with correlation score of 0.1 show very little correlation to the feeder VTHD, even though the demand is relatively high. Customer 3 loads are reported by the system as not causing harmonic distortion by the system. Customer with harmonics demand correlation score within a range of >5.0, according to some embodiments, should be investigated further as they may be potentially injecting harmonics into the distribution systems.

The system also contributes to at least the following three secondary principles: societal benefits, economic development, and efficient use of ratepayer funds. Harmonics is a growing power quality problem that impacts power electronics electrical equipment such as solar PV inverters, DERs, EV chargers and energy efficiency devices. By addressing harmonic issues, the adoption and integration of these new technologies is not hindered. Customer complaints related to harmonics involve solar PV customers whose solar systems cannot operate due to excessive grid harmonic distortion. By providing harmonics visibility and facilitate troubleshooting and resolving harmonic issues, these distributed energy resources will operate more efficiently, thereby reducing GHG emissions. Operational efficiencies achieved through implementations of the system result in lower costs of collecting harmonics data which improves the efficiency of ratepayer funds used towards operations.

In some embodiments, the system includes a Next Generation Metering Platform that makes it possible to use AMPQ to collect harmonics data which are useful for power quality investigation. In some embodiments, harmonics and other power quality data are integrated into a utility metering infrastructure which includes an AMI platform to leverage in-service revenue SmartMeters to collect power quality data in addition to billing and voltage data. The additional power quality data is useful for grid operations, asset management, and with troubleshooting power quality issues. Some embodiments include a method step to deploy and/or enable the AMPQ power quality functionality in agricultural, commercial, and industrial customer services to provide harmonics visibility to all utility distribution feeders.

In some embodiments, to integrate the system AMPQ harmonics functionality into an existing utility metering infrastructure, the system includes one or more of the following: power quality soft switches in the revenue meters for the existing smart meters that support harmonics functionality via software updates; a meter program that combines billing data, voltage data, and power quality (harmonics) data; harmonics data evaluation using the existing AMI environment to ensure there are no impacts on customer care and billing systems or other distribution management systems that rely on meter data; and a data pipeline from AMI systems to Foundry harmonics dashboard.

In some embodiments, the system described herein includes a novel way of leverage AMPQs and/or PQMs to collect harmonics data in the electric distribution systems. In some embodiments, the system is integrated, for harmonics and other power quality data analysis, into metering infrastructure in production environment. The power quality data generated is used for power quality analysis by the system, which results in improved reliability, safety, efficiency, and customer satisfaction. In some embodiments, the system is configured to automate harmonics data analysis for engineering applications to identify the source of harmonics and to conduct analysis to determine whether the level of harmonics is within IEEE 519 guidelines.

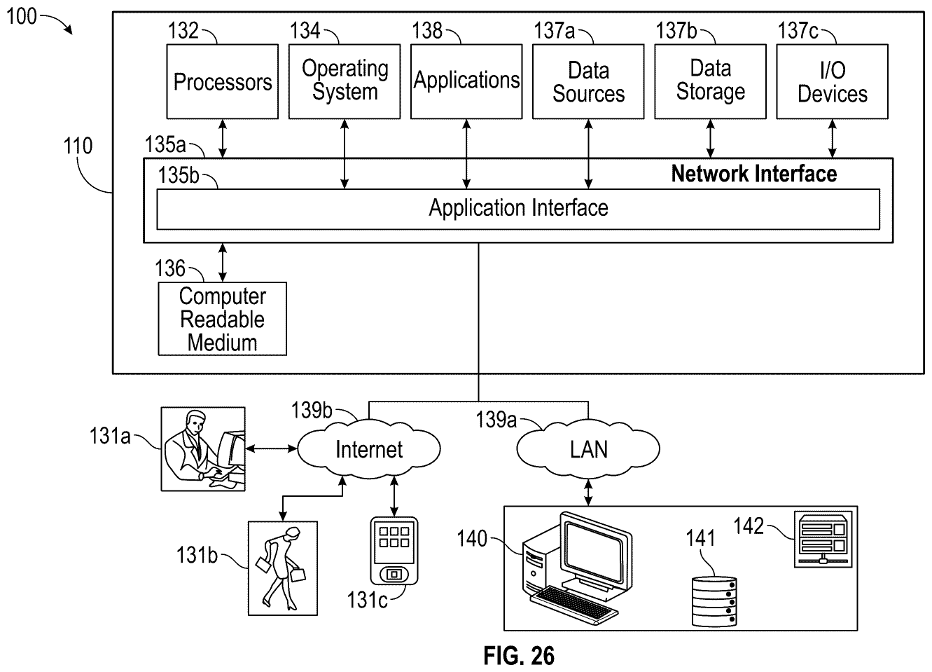

FIG. 26 illustrates a computer system 110 enabling or comprising the systems and methods according to some embodiments. In some embodiments, the computer system 110 is configured to operate and/or process computer-executable code of one or more software modules of the previously described system and method. Further, in some embodiments, the computer system 110 is configured to operate and/or display information within one or more graphical user interfaces (e.g., HMIs) integrated with or coupled to the system.

In some embodiments, the computer system 110 comprises one or more processors 132. In some embodiments, at least one processor 132 resides in, or is coupled to, one or more servers. In some embodiments, the computer system 110 includes a network interface 135a and an application interface 135b coupled to the least one processor 132 capable of processing at least one operating system 134. Further, in some embodiments, the interfaces 135a, 135b coupled to at least one processor 132 are configured to process one or more of the software modules (e.g., such as enterprise applications 138). In some embodiments, the software application modules 138 includes server-based software. In some embodiments, the software application modules 138 are configured to host at least one user account and/or at least one client account, and/or are configured to operate to transfer data between one or more of these accounts using one or more processors 132.

With the above embodiments in mind, it is understood that the system is configured to execute various computer-implemented program steps involving data stored on one or more non-transitory computer media according to some embodiments. In some embodiments, the above-described databases and models described throughout this disclosure are configured to store analytical models and other data on non-transitory computer-readable storage media within the computer system 110 and on computer-readable storage media coupled to the computer system 110 according to some embodiments. In addition, in some embodiments, the above-described applications of the system are stored on computer-readable storage media within the computer system 110 and on computer-readable storage media coupled to the computer system 110. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared, and otherwise manipulated. In some embodiments, the computer system 110 comprises at least one computer readable medium 136 coupled to at least one of at least one data source 137a, at least one data storage 137b, and/or at least one input/output 137c. In some embodiments, the computer system 110 is embodied as computer readable code on a computer readable medium 136. In some embodiments, the computer readable medium 136 includes any data storage that stores data, which is configured to thereafter be read by a computer (such as computer 140). In some embodiments, the non-transitory computer readable medium 136 includes any physical or material medium that is used to tangibly store the desired information, steps, and/or instructions and which is configured to be accessed by a computer 140 or processor 132. In some embodiments, the non-transitory computer readable medium 136 includes hard drives, network attached storage (NAS), read-only memory, random-access memory, FLASH-based memory, CD-ROMs, CD-Rs, CD-RWs, DVDs, magnetic tapes, and/or other optical and non-optical data storage. In some embodiments, various other forms of computer-readable media 136 are configured to transmit or carry instructions to one or more remote computers 140 and/or at least one user 131, including a router, private or public network, or other transmission or channel, both wired and wireless. In some embodiments, the software application modules 138 are configured to send and receive data from a database (e.g., from a computer readable medium 136 including data sources 137a and data storage 137b that comprises a database), and data is configured to be received by the software application modules 138 from at least one other source. In some embodiments, at least one of the software application modules 138 are configured to be implemented by the computer system 110 to output data to at least one user 131 via at least one graphical user interface rendered on at least one digital display.

In some embodiments, the one or more non-transitory computer readable 136 media are distributed over a conventional computer network via the network interface 135a where some embodiments stored the non-transitory computer readable media are stored and executed in a distributed fashion. For example, in some embodiments, one or more components of the computer system 110 are configured to send and/or receive data through a local area network (“LAN”) 139a and/or an internet coupled network 139b (e.g., such as a wireless internet). In some embodiments, the networks 139a, 139b include one or more wide area networks (“WAN”), direct connections (e.g., through a universal serial bus port), or other forms of computer-readable media 136, and/or any combination thereof.

In some embodiments, components of the networks 139a, 139b include any number of personal computers 140 which include for example desktop computers, laptop computers, and/or any fixed, generally non-mobile internet appliances coupled through the LAN 139a. For example, some embodiments include one or more personal computers 140, databases 141, and/or servers 142 coupled through the LAN 139a that are configured for use by any type of user including an administrator. Some embodiments include one or more personal computers 140 coupled through network 139b. In some embodiments, one or more components of the computer system 110 are configured to send or receive data through an internet network (e.g., such as network 139b). For example, some embodiments include at least one user 131a, 131b, coupled wirelessly and accessing one or more software modules of the system including at least one enterprise application 138 via an input and output (“I/O”) 137c. In some embodiments, the computer system 110 is configured to enable at least one user 131a, 131b, to be coupled to access enterprise applications 138 via an I/O 137c through LAN 139a. In some embodiments, the user 131 includes a user 131a coupled to the computer system 110 using a desktop computer, and/or laptop computers, or any fixed, generally non-mobile internet appliances coupled through the internet 139b. In some embodiments, the user includes a mobile user 131b coupled to the computer system 110. In some embodiments, the user 131b connects using any mobile computing 131c to wireless coupled to the computer system 110, including, but not limited to, one or more personal digital assistants, at least one cellular phone, at least one mobile phone, at least one smart phone, at least one pager, at least one digital tablet, and/or at least one fixed or mobile internet appliances.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. A system comprising:
two or more smart meters each configured to monitor a respective electrical load, and
one or more computers comprising one or more processors and one or more non-transitory computer readable media, the one or more non-transitory computer readable media including program instructions stored thereon that when executed cause the one or more computers to:
receive, by the one or more processors, electrical load data from the two or more smart meters;
receive, by the one or more processors, harmonic distortion data from one or more electrical distribution devices;
execute, by the one or more processors, a correlation analysis that includes the electrical load data from each of the two or more smart meters and the harmonic distortion data;
identify, by the one or more processors, a harmonic distortion source based on the correlation analysis; and
output, by the one or more processors, a report identifying the harmonic distortion source.

2. The system of claim 1,
wherein the one or more electrical distribution devices include at least one of the two or more smart meters.

3. The system of claim 2,
wherein the harmonic distortion data is recorded by at least one of the two or more smart meters.

4. The system of claim 3,
wherein at least one of the two or more smart meters is configured to sample electrical waveforms at a frequency greater than 60 Hz.

5. The system of claim 3,
wherein at least one of the two or more smart meters is configured to sample electrical waveforms at a frequency greater than 300 Hz.

6. The system of claim 3,
wherein at least one of the two or more smart meters is configured to sample electrical waveforms at a frequency between 1000 Hz and 6000 Hz.

7. The system of claim 3,
wherein at least one of the two or more smart meters is configured to detect harmonics greater than or equal to a 7th harmonic.

8. The system of claim 3,
wherein at least one of the two or more smart meters is configured to detect harmonics occurring in a feeder; and
wherein the feeder is configured to supply electricity to the two or more smart meters.

9. The system of claim 1,
wherein identifying the harmonic distortion source includes displaying an area on a map a location where the harmonic distortion source has been identified.

10. The system of claim 1,
wherein identifying the harmonic distortion source includes identifying which of the two or more smart meters are coupled to the electrical load causing harmonic distortion.

11. The system of claim 1,
wherein the one or more electrical distribution devices include a power quality monitor.

12. The system of claim 1,
wherein the one or more electrical distribution devices include a phasor measurement unit installed on a distribution line.

13. The system of claim 1,
wherein the one or more electrical distribution devices include a line sensor installed on a distribution line.

14. The system of claim 1,
wherein outputting the report includes displaying the harmonic distortion source on a graphical user interface.

15. The system of claim 1,
wherein outputting the report includes displaying harmonics data for at least one of the two or more smart meters.

16. The system of claim 1,
wherein outputting the report includes displaying harmonics data at a feeder level.

17. The system of claim 1,
wherein at least one of the two or more smart meters is configured to collect total voltage harmonic distortion data and/or total current harmonic distortion data.

18. The system of claim 17,
wherein at least one of the two or more smart meters is configured to send the total voltage harmonic distortion data and/or the total current harmonic distortion data to a utility server at predetermined intervals.
